(19) United States
(12) Patent Application Publication
(10) Pub. No.: US 2025/0315143 A1
(43) Pub. Date: Oct. 9, 2025

(54) Devices, Methods, and Graphical User Interfaces for Updating a Cursor of an Input Device

(71) Applicant: Apple Inc., Cupertino, CA (US)

(72) Inventor: Marcos Alonso Ruiz, Oakland, CA (US)

(21) Appl. No.: 19/096,401

(22) Filed: Mar. 31, 2025

Related U.S. Application Data
(60) Provisional application No. 63/575,555, filed on Apr. 5, 2024.
(60) Provisional application No. 63/662,365, filed on Jun. 20, 2024.

(51) Int. Cl. G06F 3/04812; G06F 3/01; G06F 3/0346; G06F 3/0354; G06F 3/0485; G06F 3/16

(52) U.S. Cl. CPC G06F 3/04812; G06F 3/016; G06F 3/0346; G06F 3/03543; G06F 3/0485; G06F 3/165

(57) ABSTRACT

A computer system, while displaying, via the display generation component, a first user interface, while a current cursor location for a cursor corresponding to the input device is at a first location of the first user interface: in response to detecting first movement of the input device: in accordance with a determination that the first movement includes lateral movement of the input device relative to a physical surface that the input device is touching, updates display of the cursor as moving based on the lateral movement of the input device on the physical surface; and in accordance with a determination that the first movement includes a change in orientation of the input device, performs a system operation that is determined based at least in part on an amount of the change in orientation of the first movement.

### RELATED APPLICATIONS

This application claims priority to U.S. Provisional Patent Application No. 63/662,365, filed Jun. 20, 2024, and U.S. Provisional Patent Application No. 63/575,555, filed Apr. 5, 2024, each of which is incorporated by reference in its entirety.

### TECHNICAL FIELD

This relates generally to electronic devices with input devices, including but not limited to electronic devices that are in communication with one or more input devices for performing operations by the electronic device.

### BACKGROUND

The use of computer-mouse (“mouse”) based inputs for computers and other electronic computing devices has increased significantly in recent years. Such inputs are widely used to manipulate user interfaces and user interface objects therein on a display. Example user interface objects include digital images, video, text, icons, and control elements such as buttons and other graphics. The use of mouse based inputs may limit a range of motion for providing inputs and may limit the types of interactions for controlling computing devices.

### SUMMARY

The above deficiencies and other problems associated with user interfaces for electronic devices (or more generally, computer systems) are reduced or eliminated by the disclosed devices, including the disclosed input device for controlling electronic devices. In some embodiments, the electronic device is a desktop computer. In some embodiments, the electronic device is portable (e.g., a notebook computer, tablet computer, or handheld device). In some embodiments, the electronic device is a personal electronic device (e.g., a wearable electronic device, such as a watch). In some embodiments, the device has a touchpad. In some embodiments, the device has a touch-sensitive display (also known as a “touch screen” or “touch-screen display”). In some embodiments, the electronic device has a graphical user interface (GUI), one or more processors, memory and one or more modules, programs or sets of instructions stored in the memory for performing multiple functions. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system that is in communication with a display generation component and an input device. The method includes, while displaying, via the display generation component, a first user interface, while a current cursor location for a cursor corresponding to the input device is at a first location of the first user interface: in response to detecting first movement of the input device: in accordance with a determination that the first movement includes lateral movement of the input device relative to a physical surface that the input device is touching, updating display of the cursor as moving based on the lateral movement of the input device on the physical surface; and in accordance with a determination that the first movement includes a change in orientation of the input device, performing a system operation that is determined based at least in part on an amount of the change in orientation of the first movement.

In accordance with some embodiments, a method is performed at a computer system that is in communication with a display generation component and an input device. The method includes, while displaying, via the display generation component, a first user interface and while a current cursor location for a cursor corresponding to the input device is at a first position in the first user interface, detecting movement of the input device. The method includes, in response to detecting the movement of the input device: in accordance with a determination that the movement includes lateral movement of the input device relative to a physical surface that the input device is touching, displaying movement of the cursor to a second position in the first user interface based on the lateral movement of the input device relative to the physical surface; and in accordance with a determination that the movement includes lifting the input device away from the physical surface, displaying movement of the cursor to a third position in the first user interface based on a distance between the input device and the physical surface.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, input devices, optionally touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for providing inputs using an input device thereby increasing the effectiveness, efficiency, and user satisfaction with such devices. Such methods and interfaces may complement or replace conventional methods for providing inputs using an input device.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 5A-5C illustrate an example input device for providing inputs in accordance with some embodiments.

FIGS. 5D-5AL illustrate example user interfaces based on inputs detected by an input device in accordance with some embodiments.

FIGS. 6A-6F are flow diagrams of a process for detecting movements of an input device and moving a cursor and/or performing a system operation in accordance with the detected movements in accordance with some embodiments.

FIGS. 7A-7D are flow diagrams of a process for moving a cursor based on movements of an input device relative to a physical surface in accordance with some embodiments.

### DESCRIPTION OF EMBODIMENTS

A computer system is provided that is in communication with an input device that controls a position of a cursor to navigate a user interface displayed by a display device of the computer system. The input device provides inputs while touching and while not touching a physical surface, for example after being lifted off the physical surface. The input device provides different types of inputs based on different types of movements of the input device, including lateral, vertical and/or rotational movements across six degrees of freedom.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

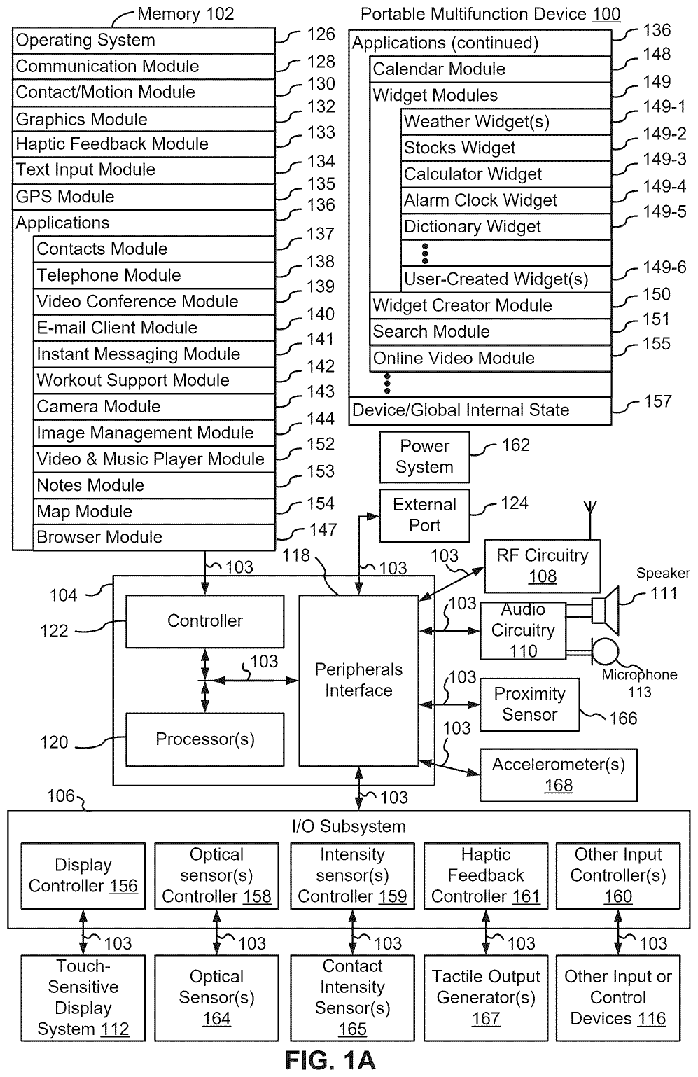

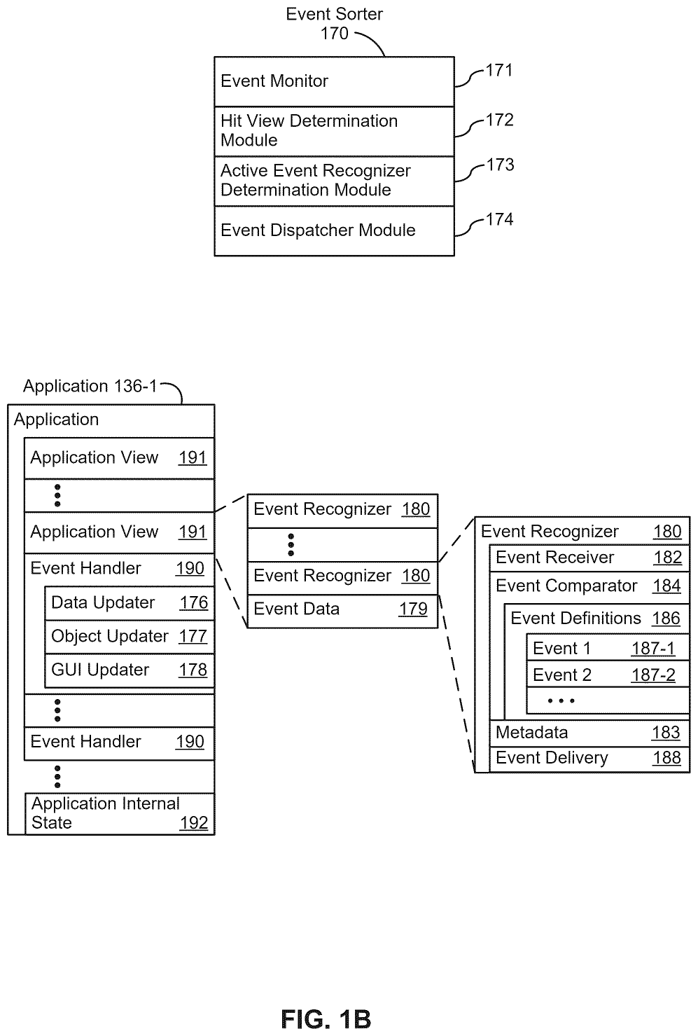

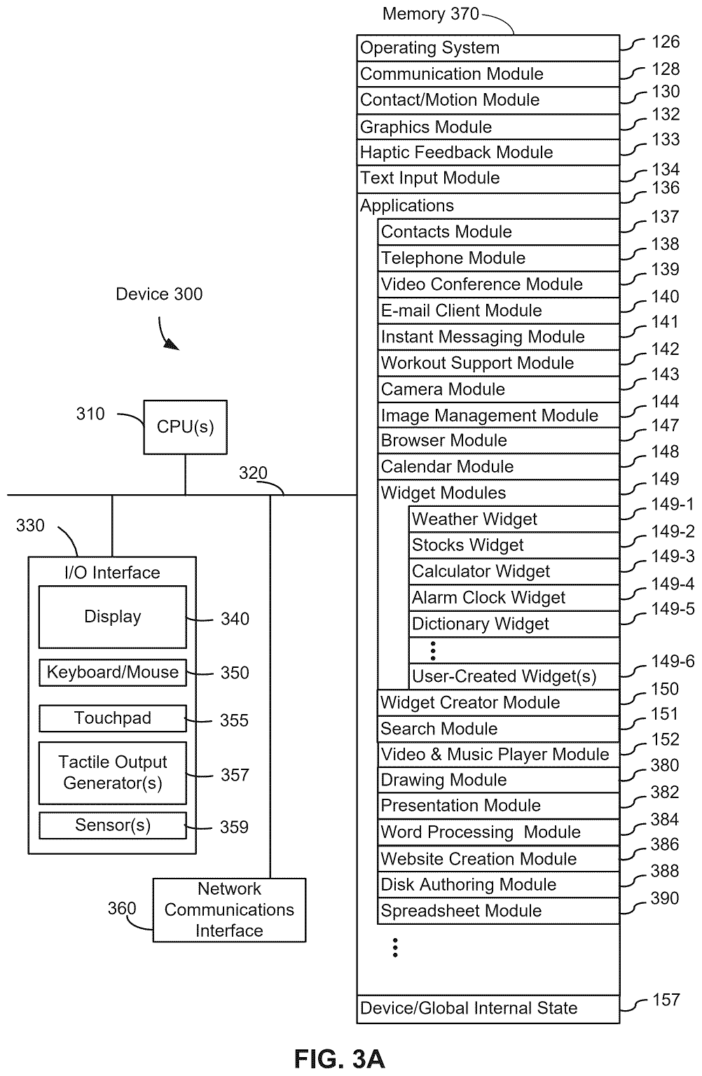

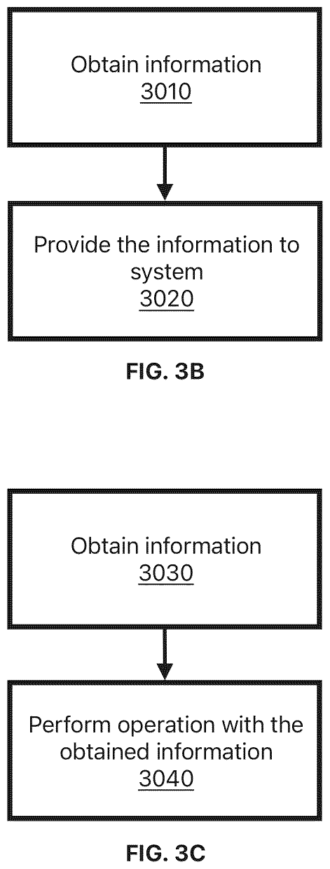

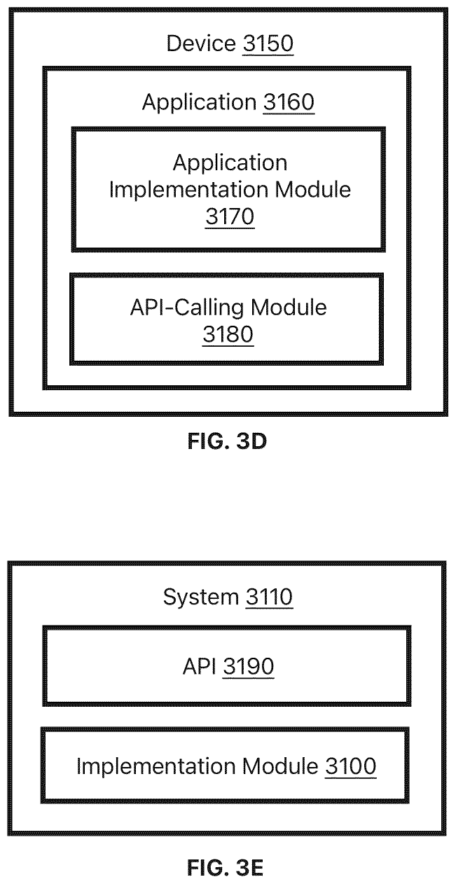

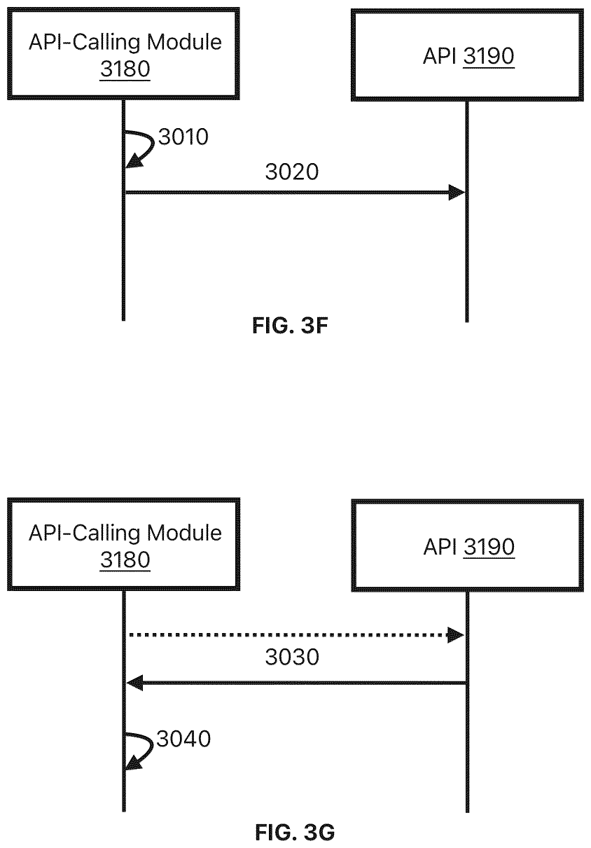

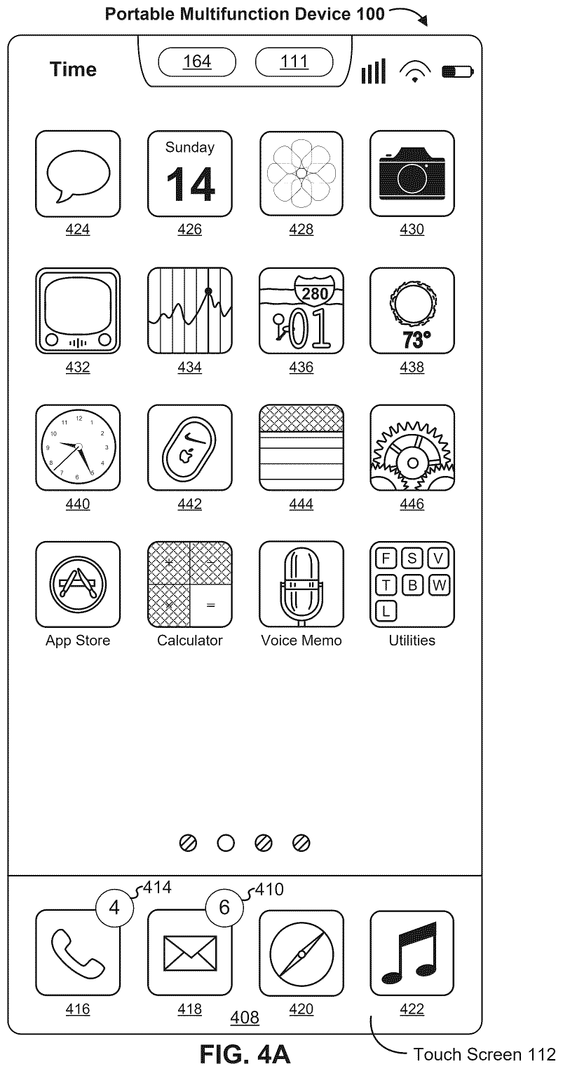

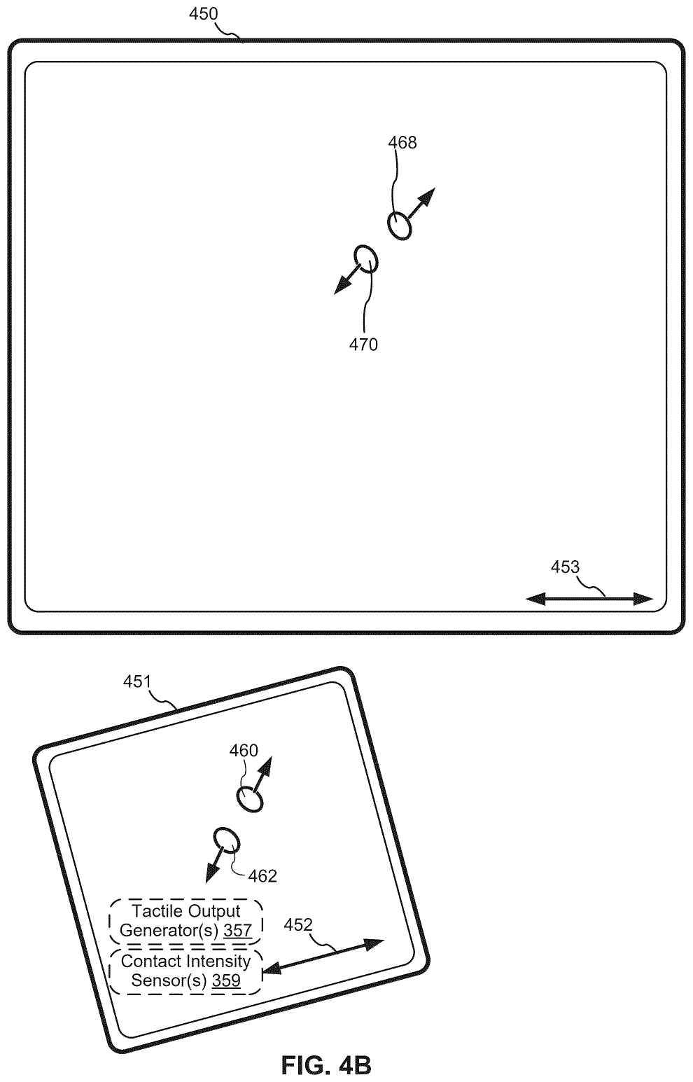

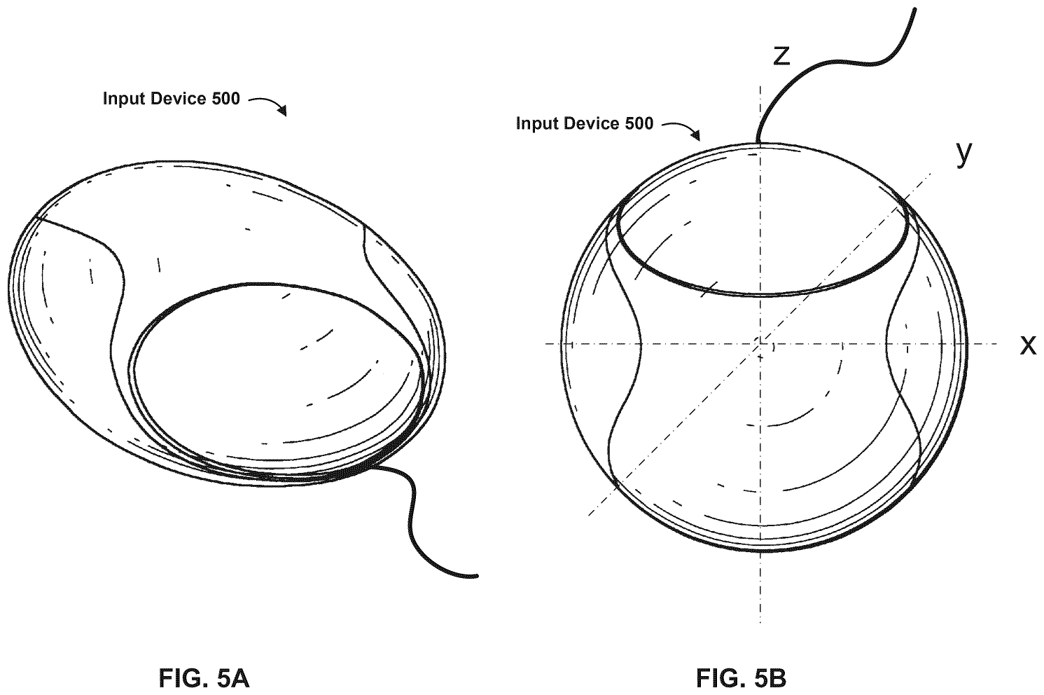

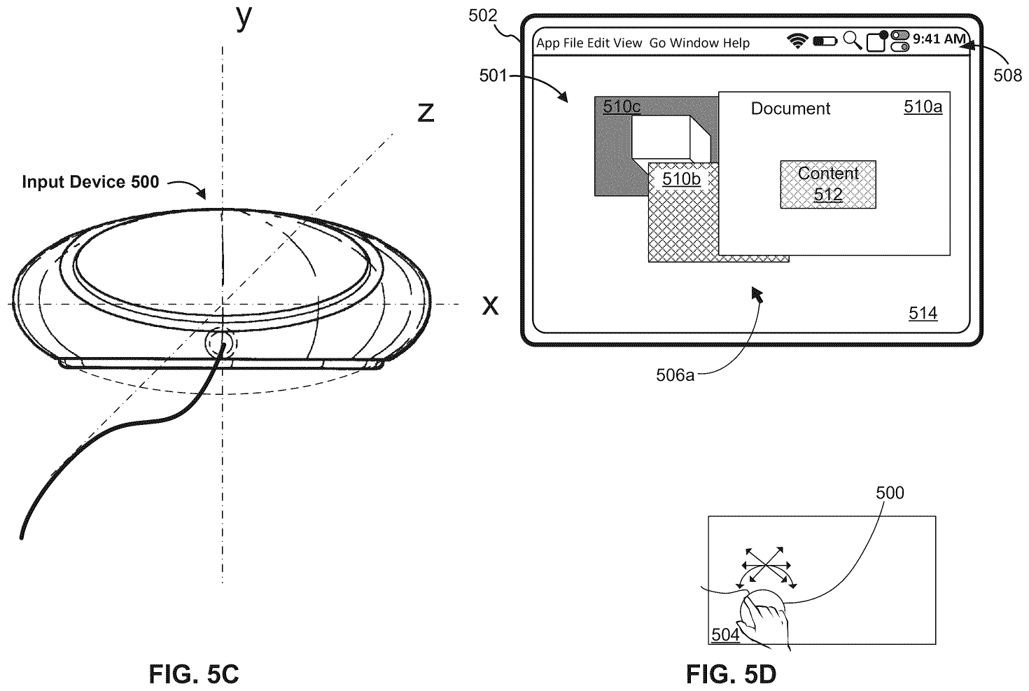

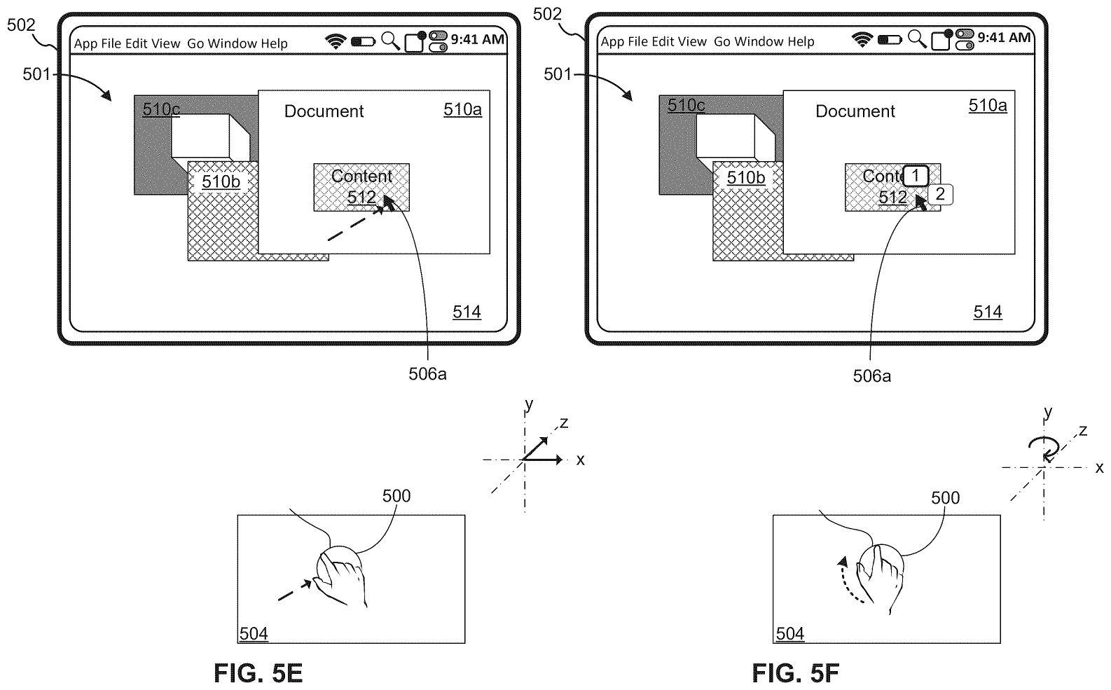

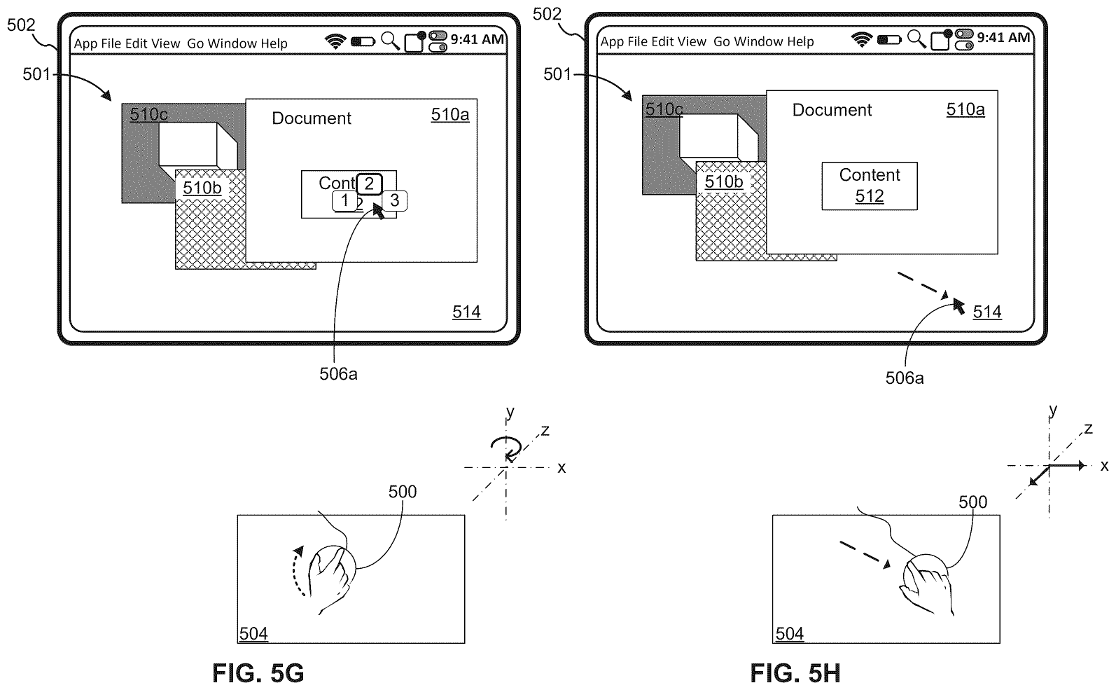

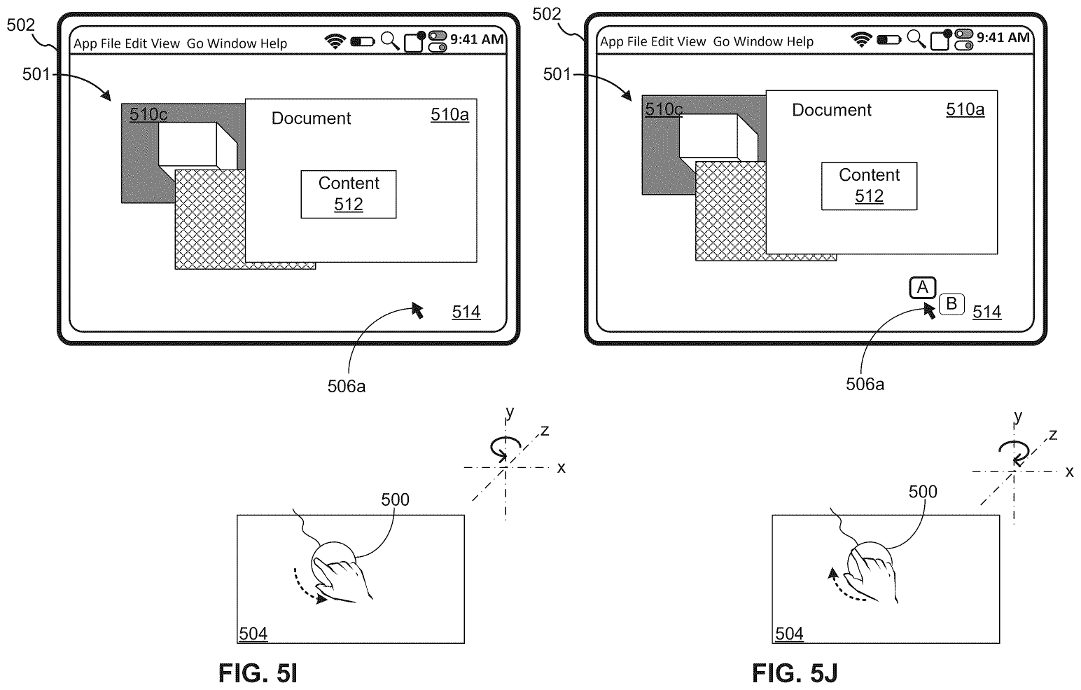

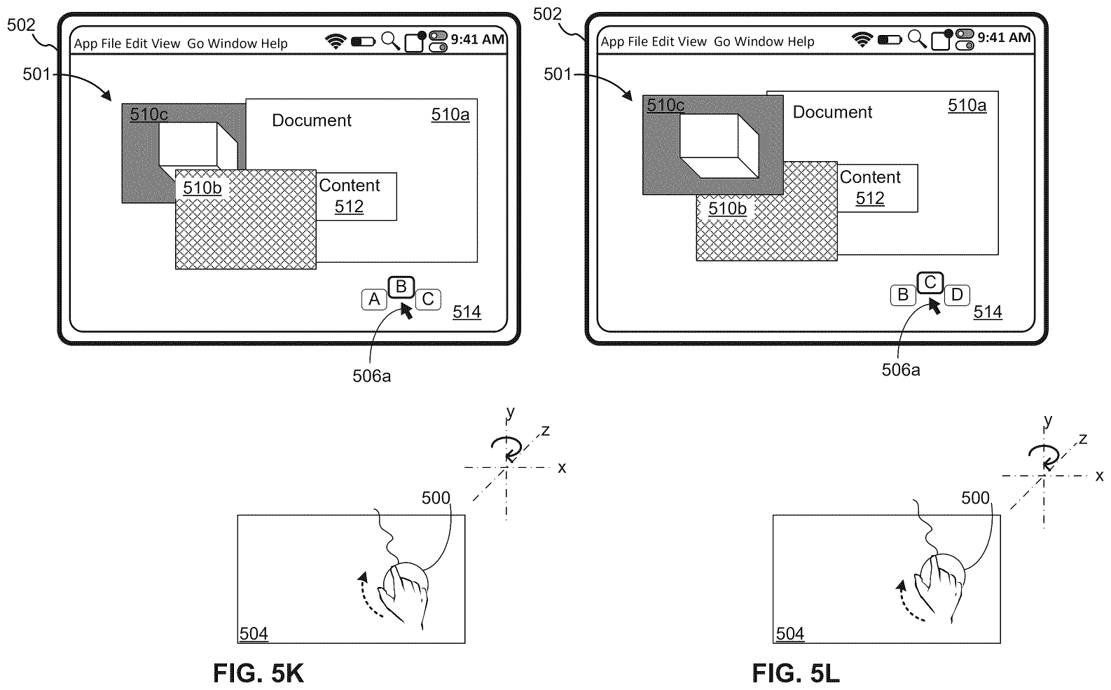

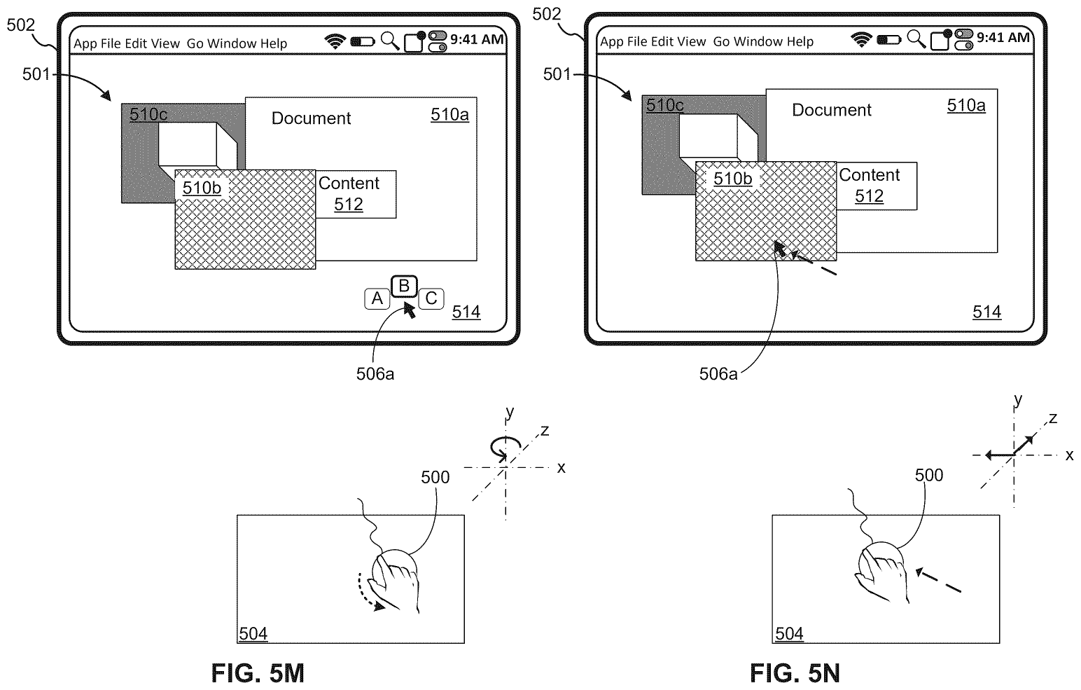

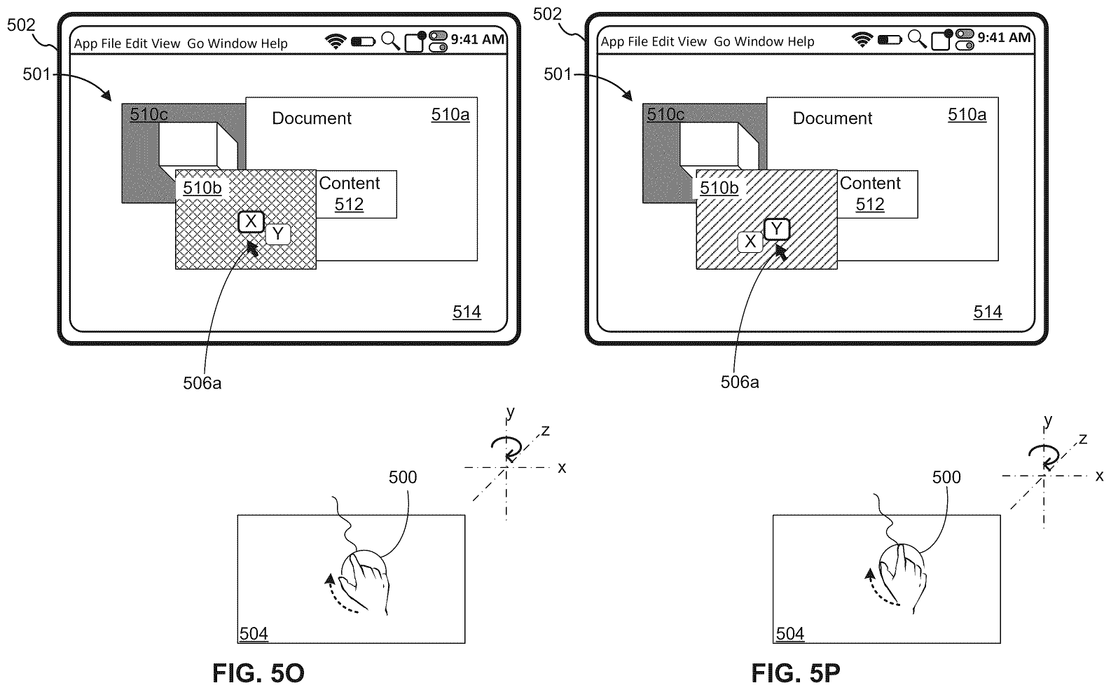

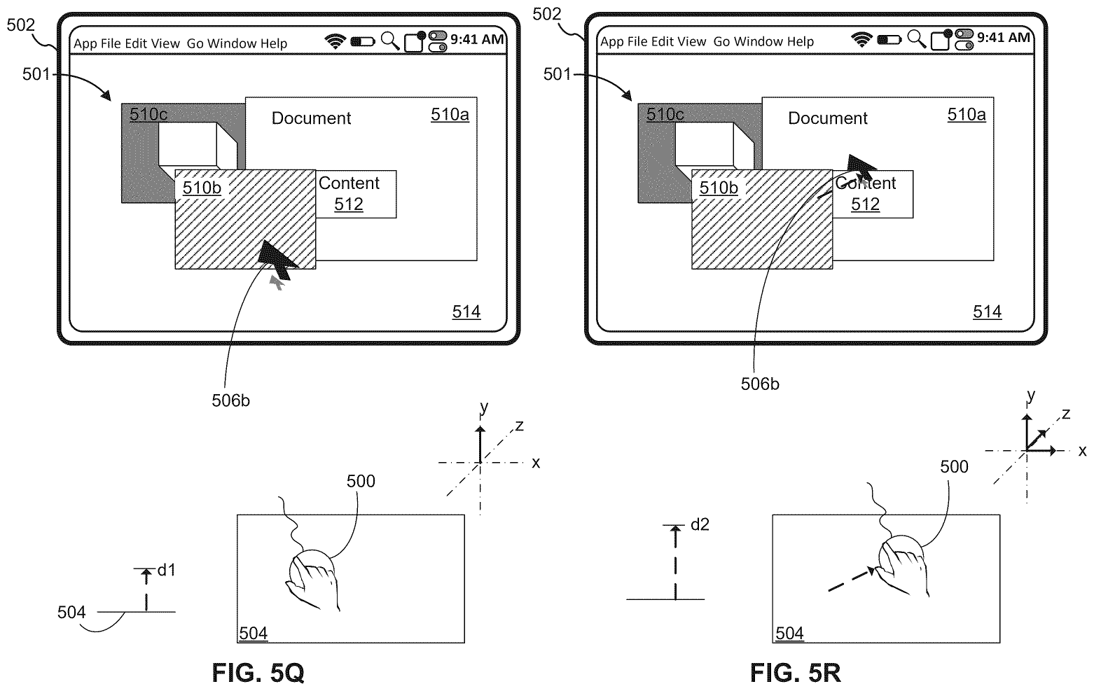

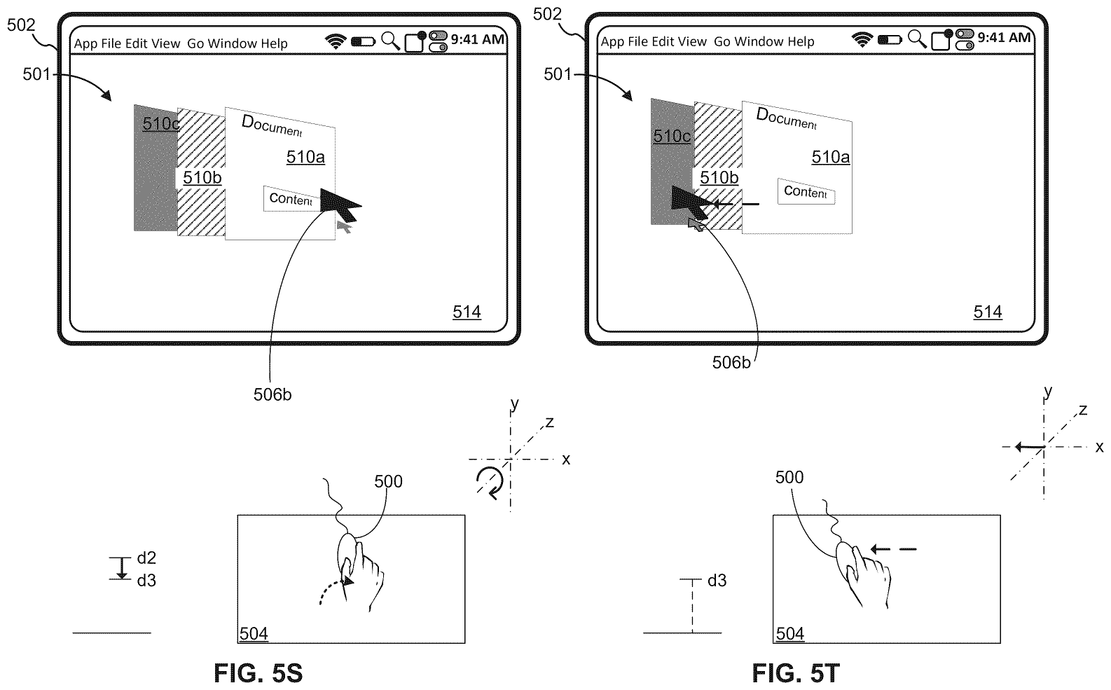

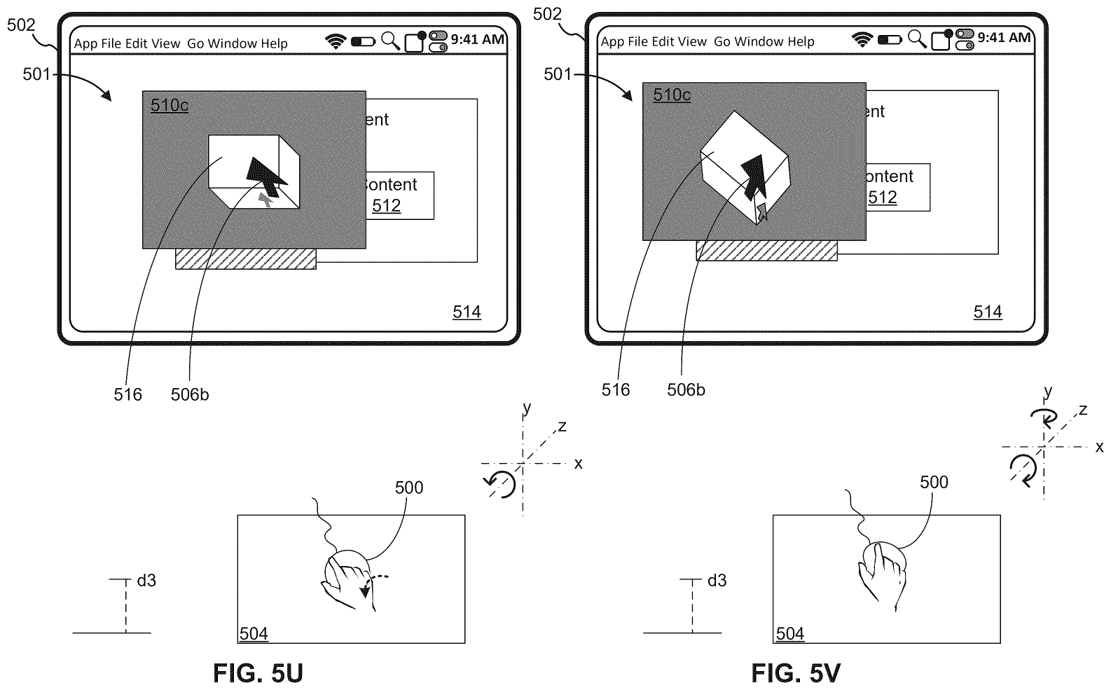

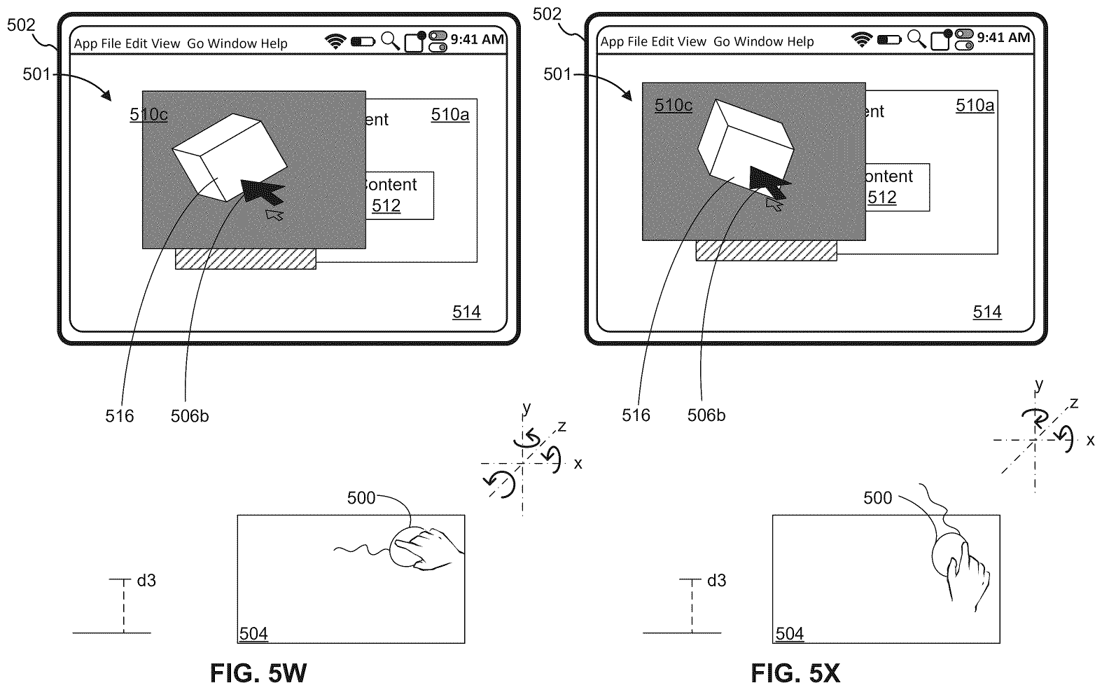

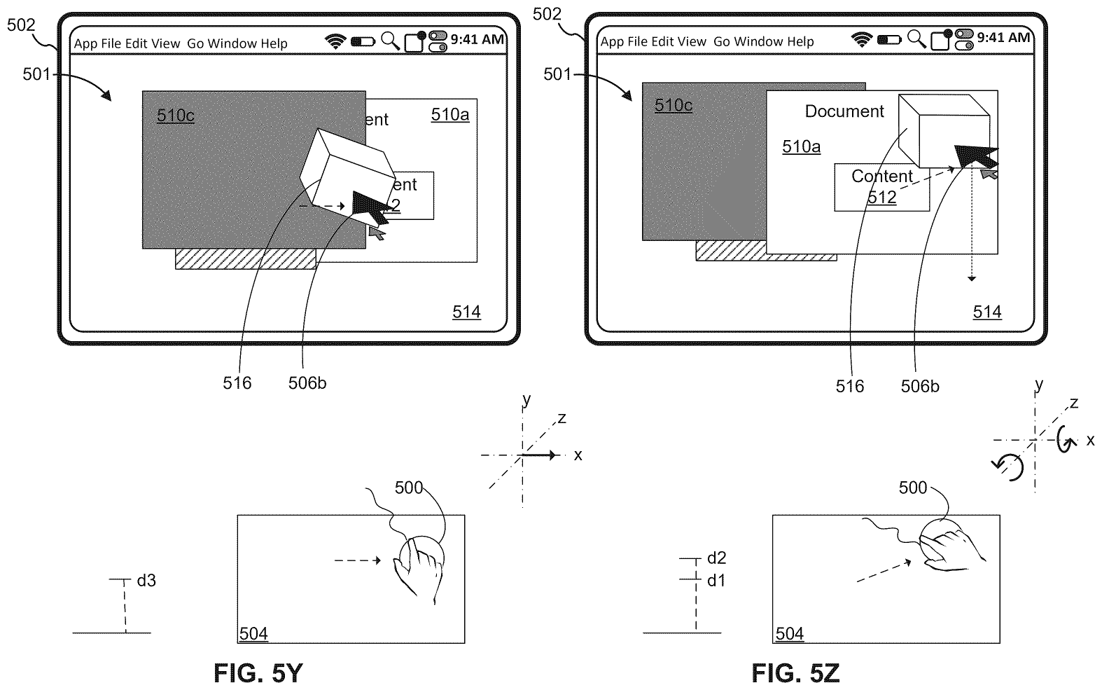

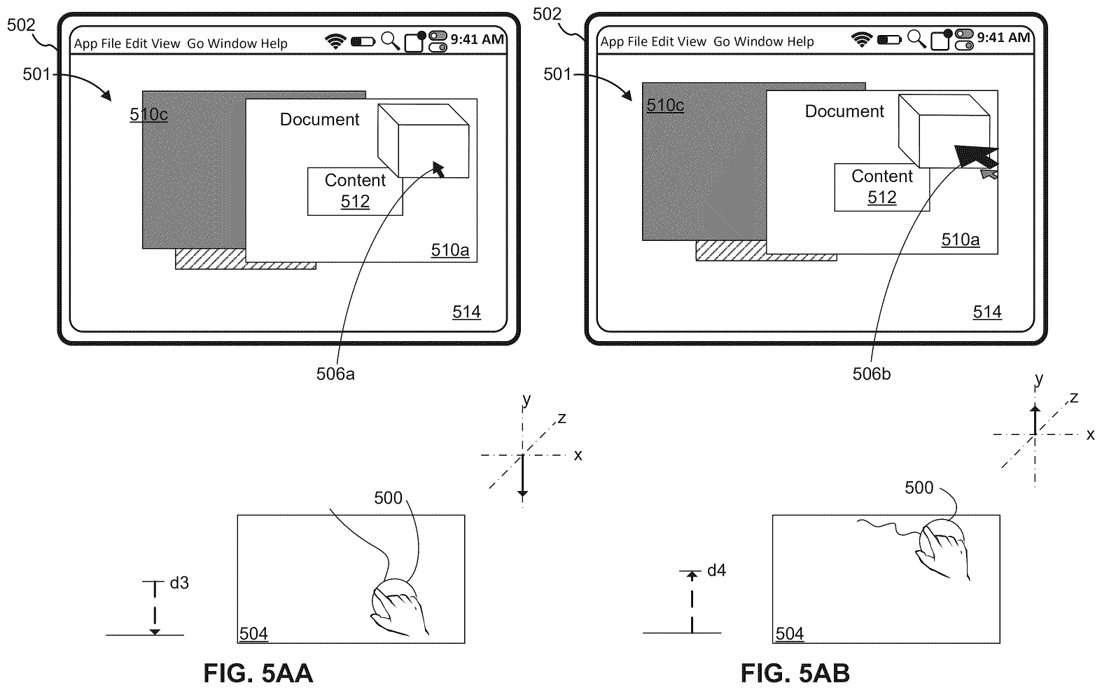

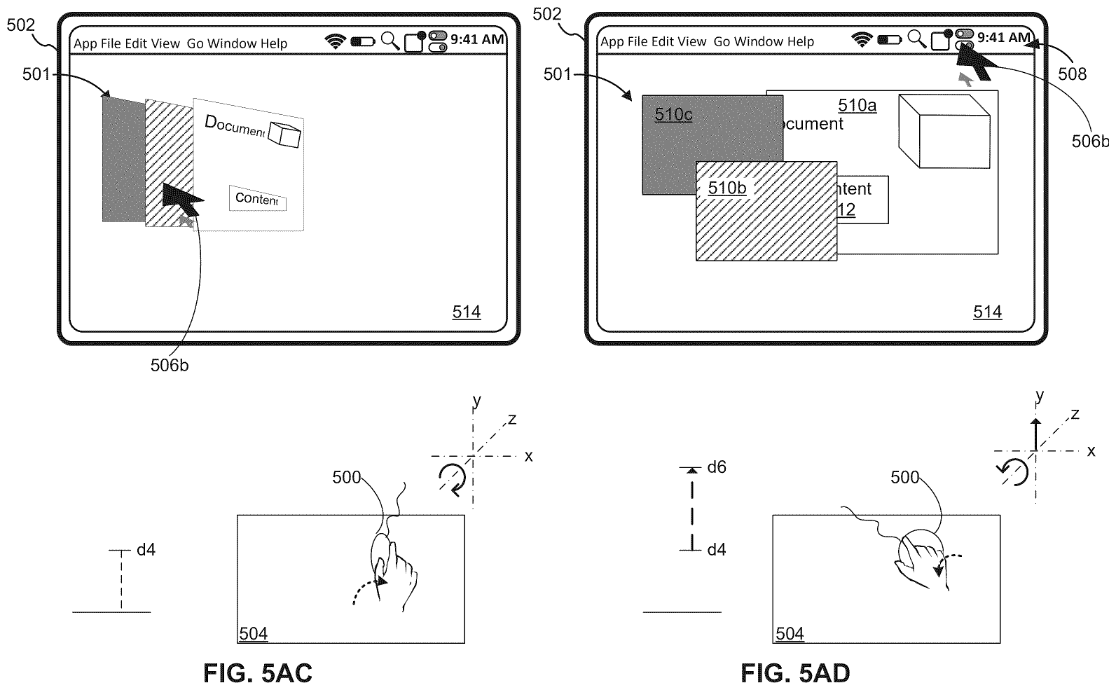

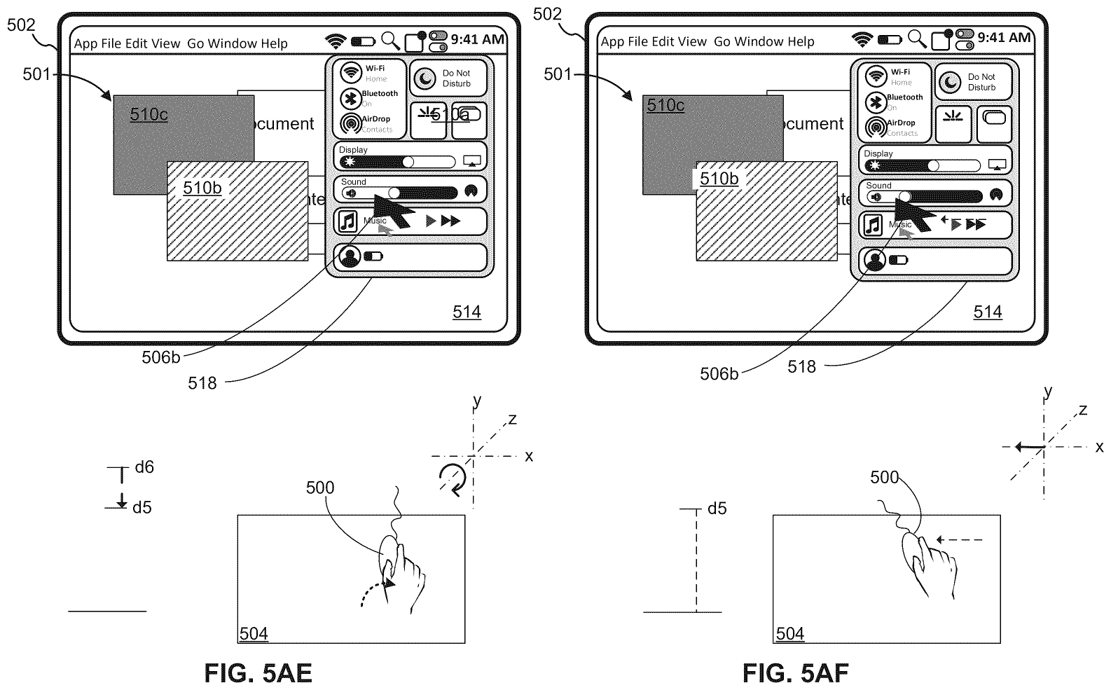

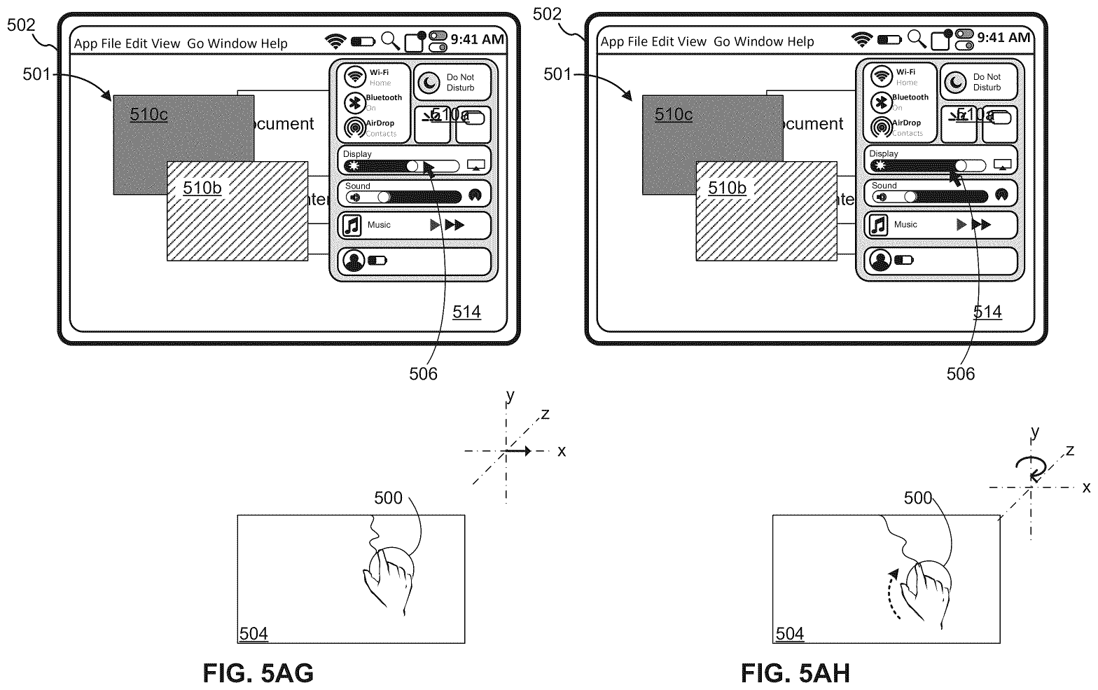

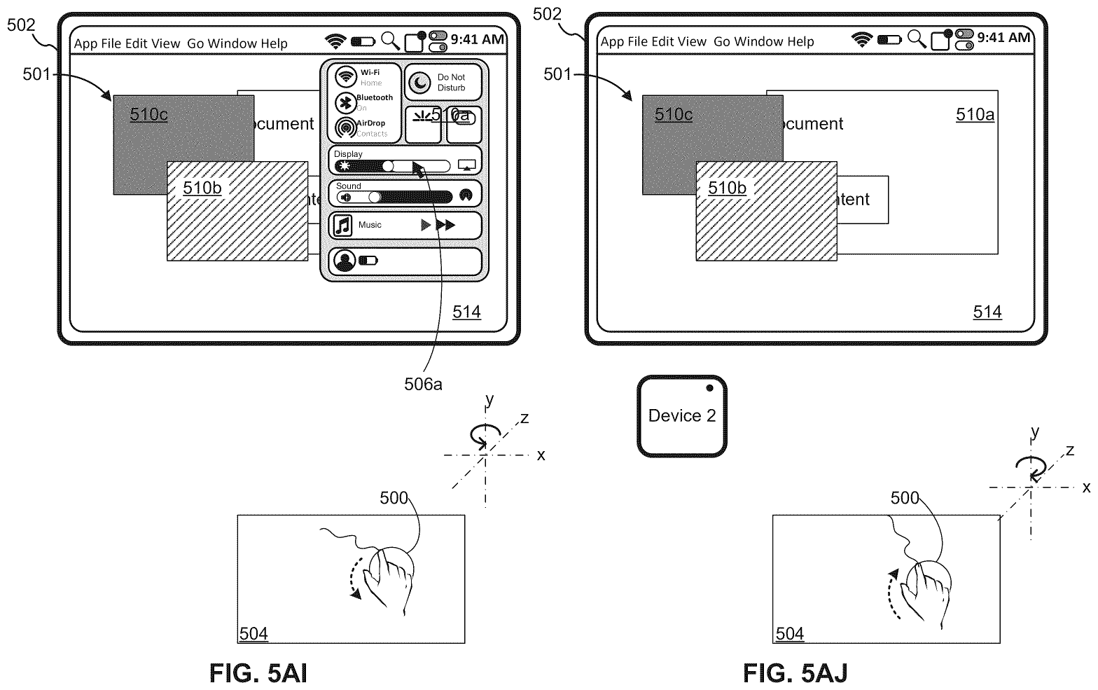

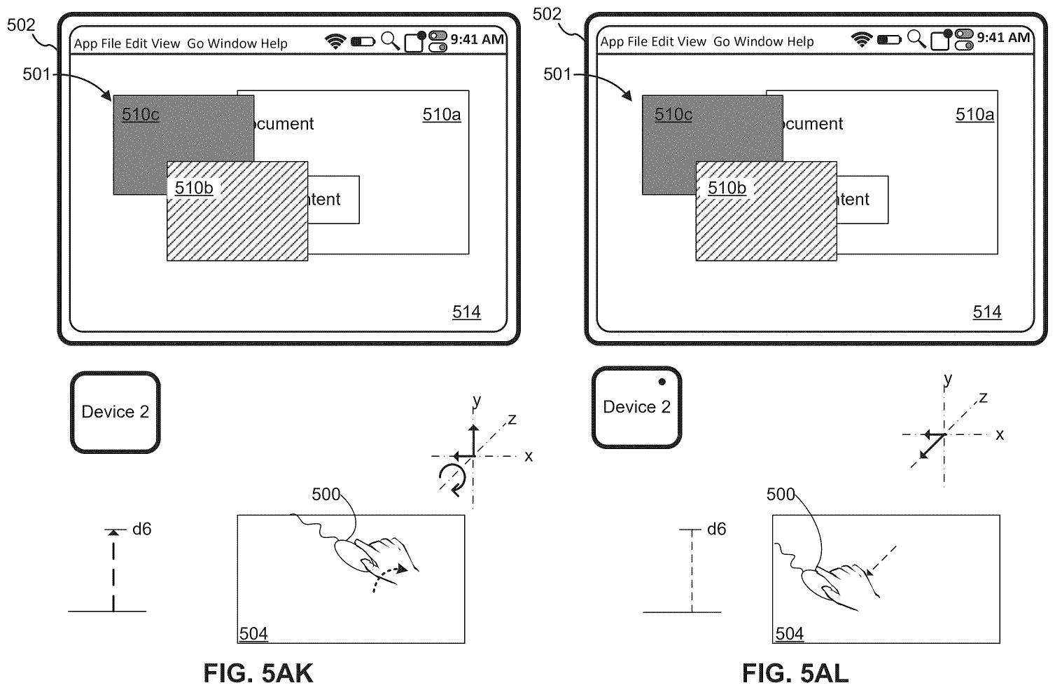

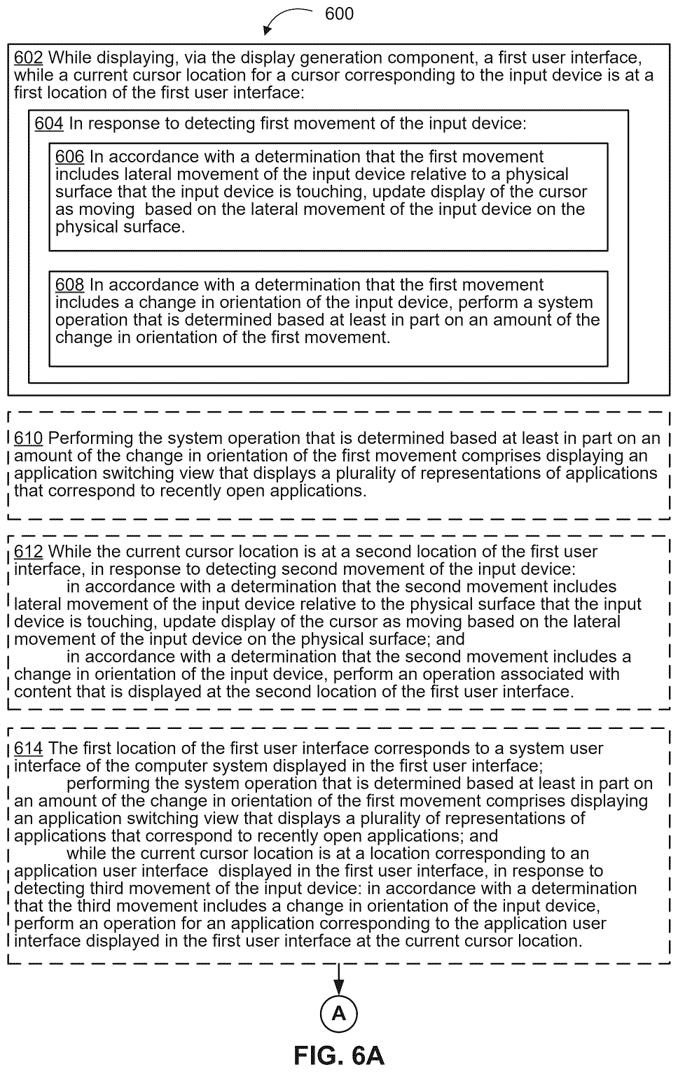

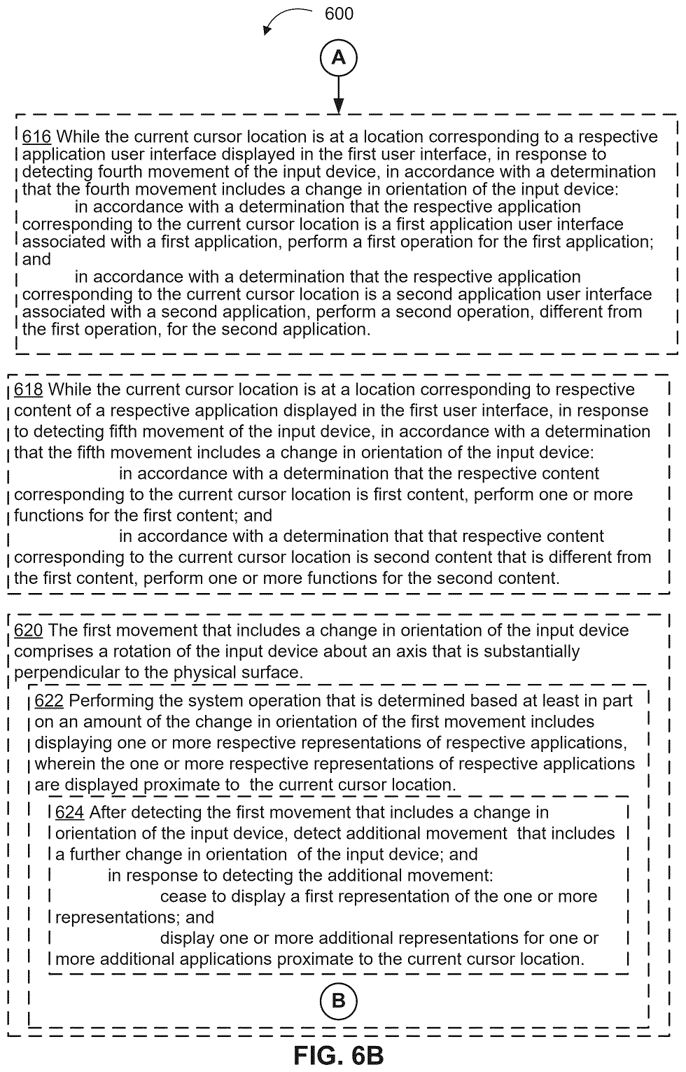

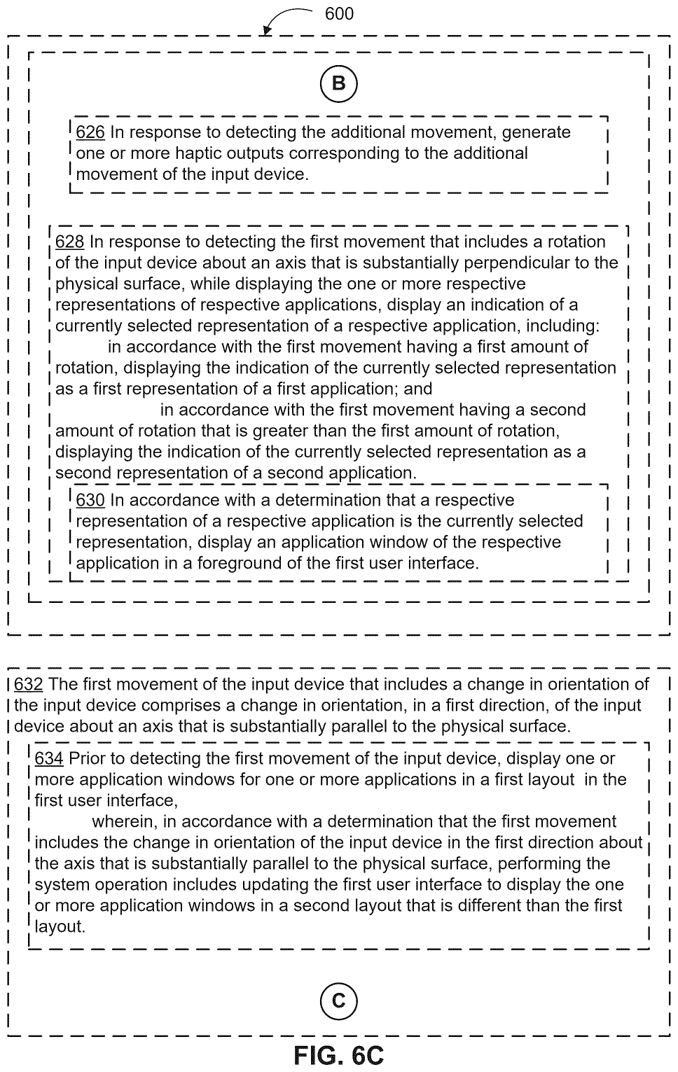

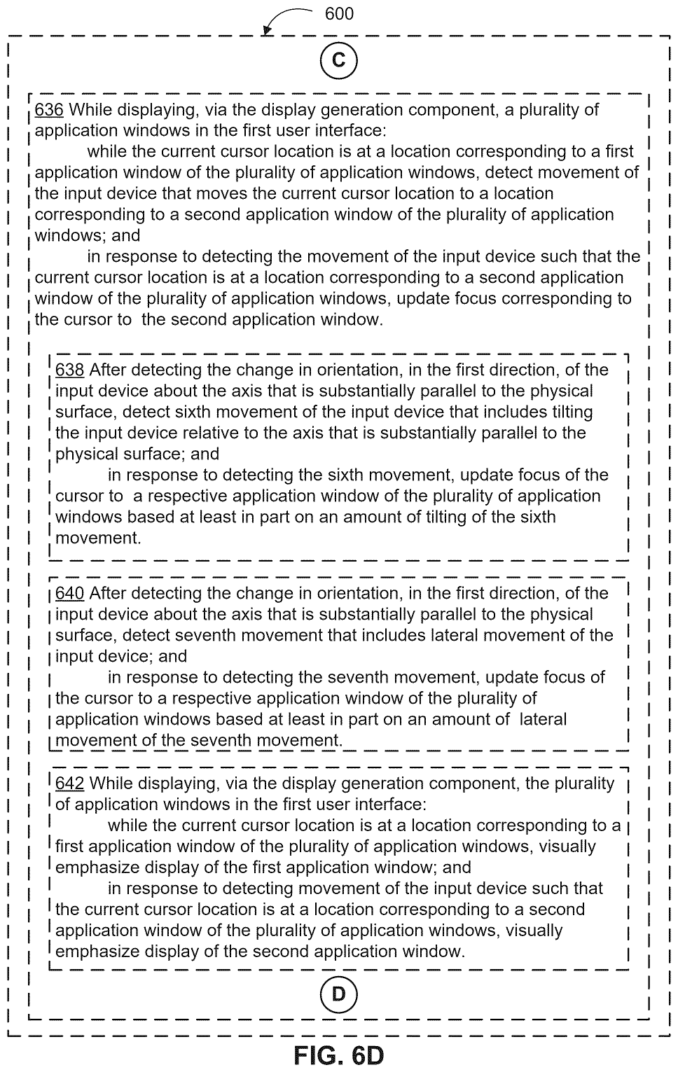

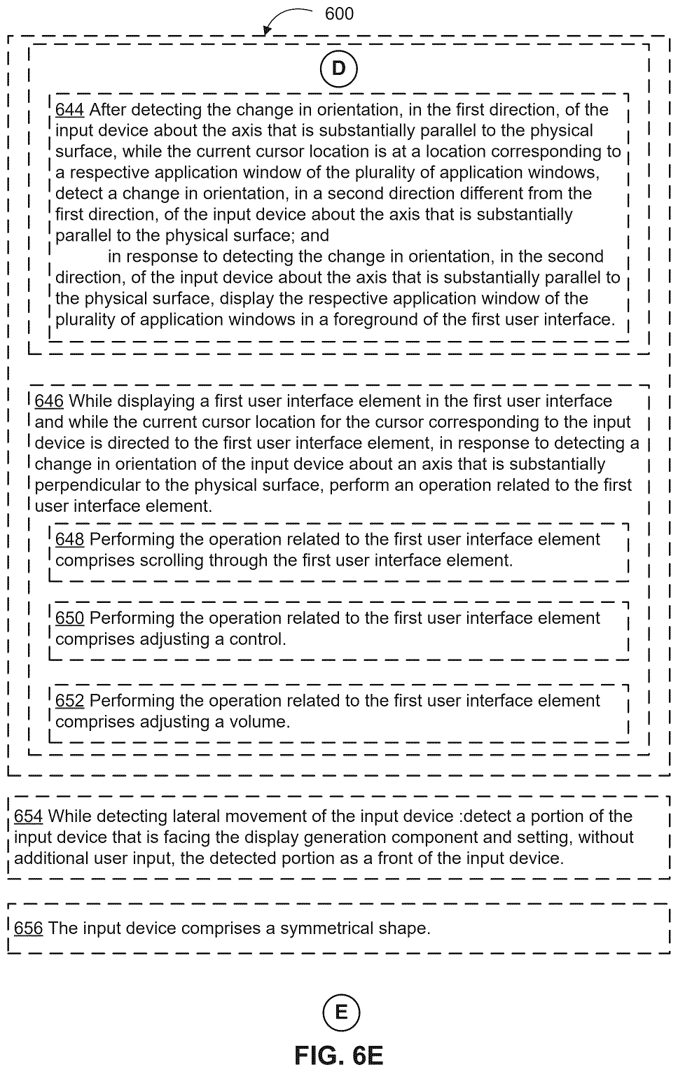

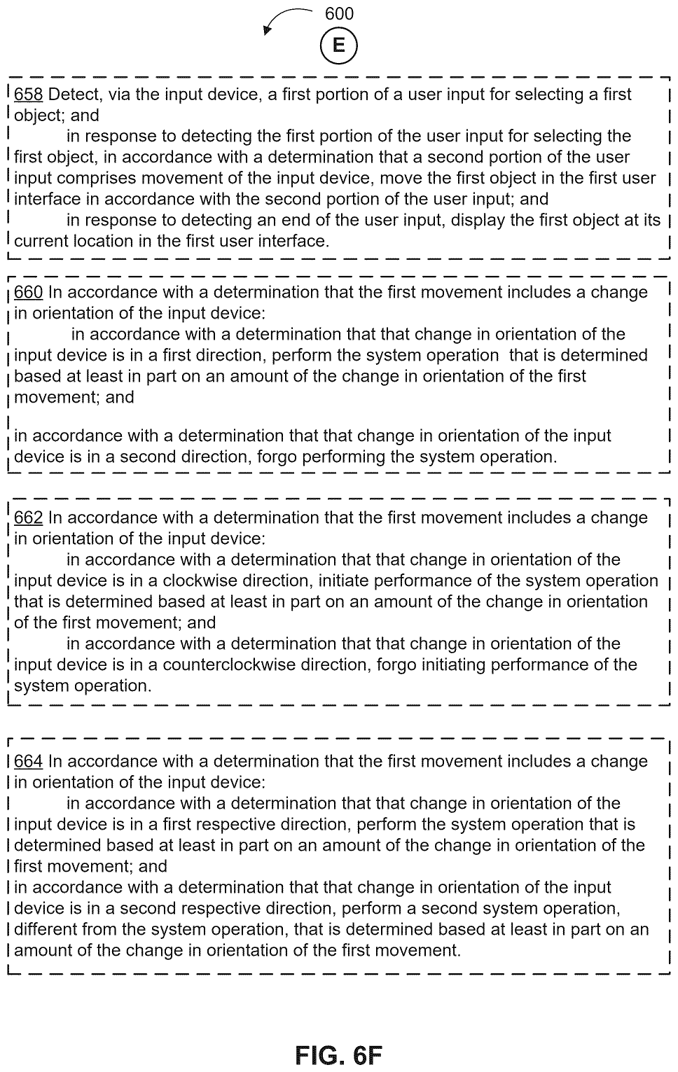

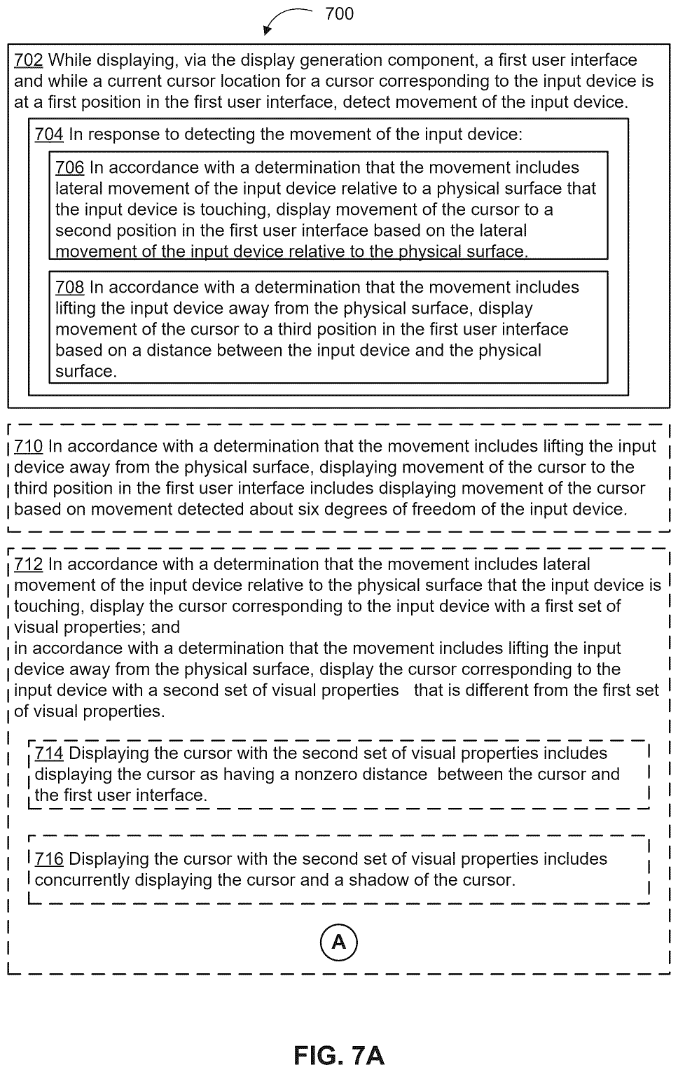

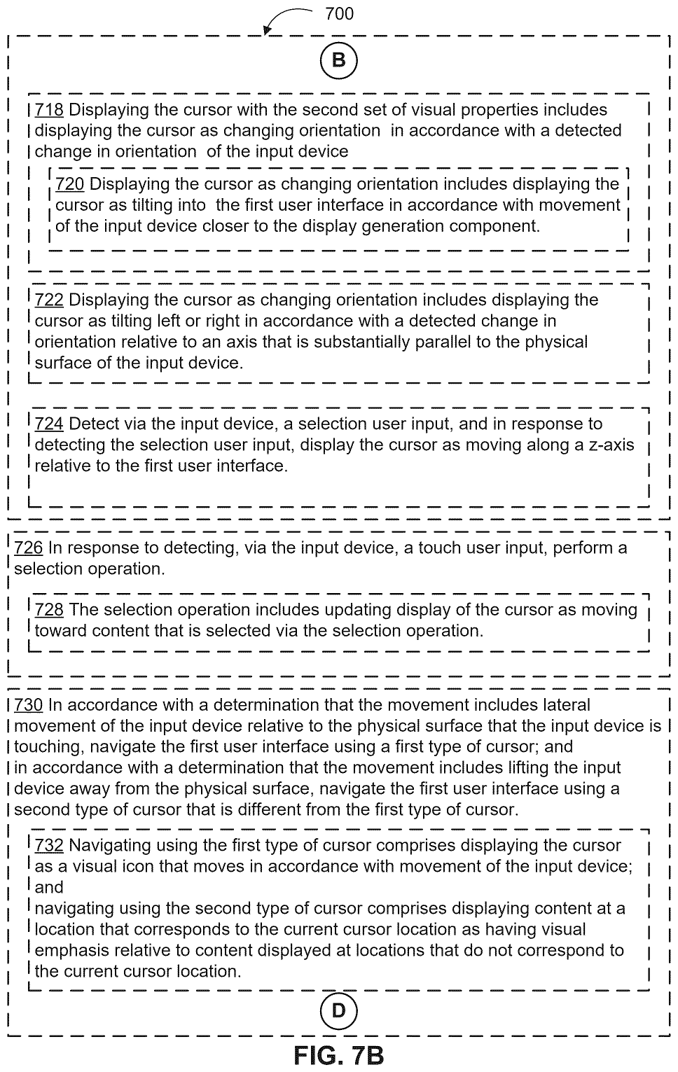

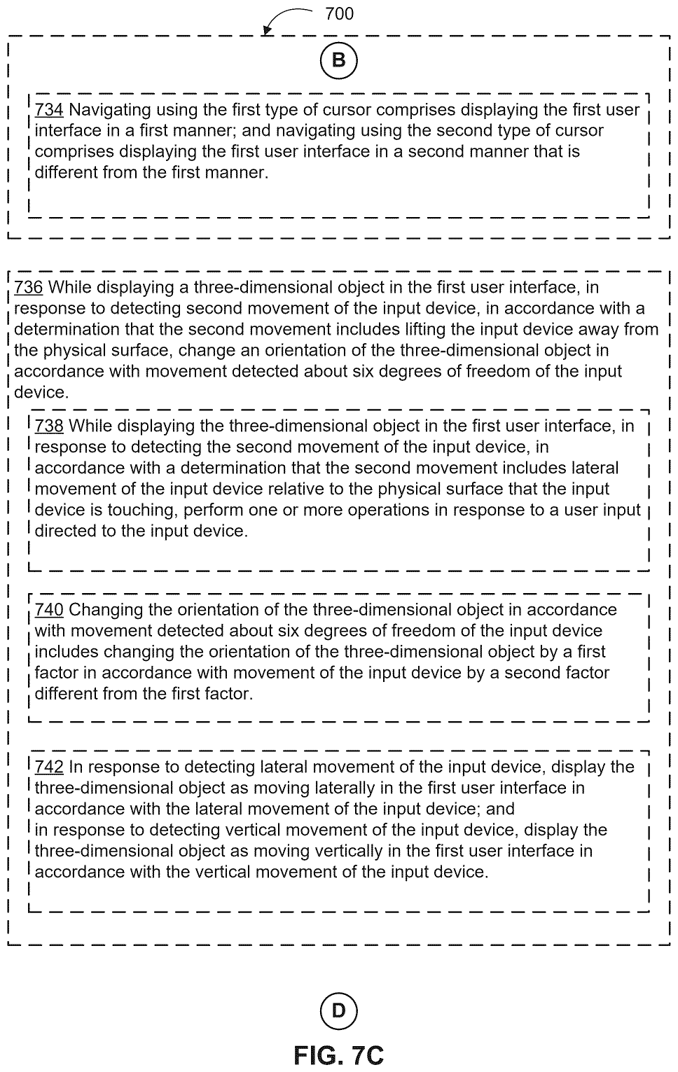

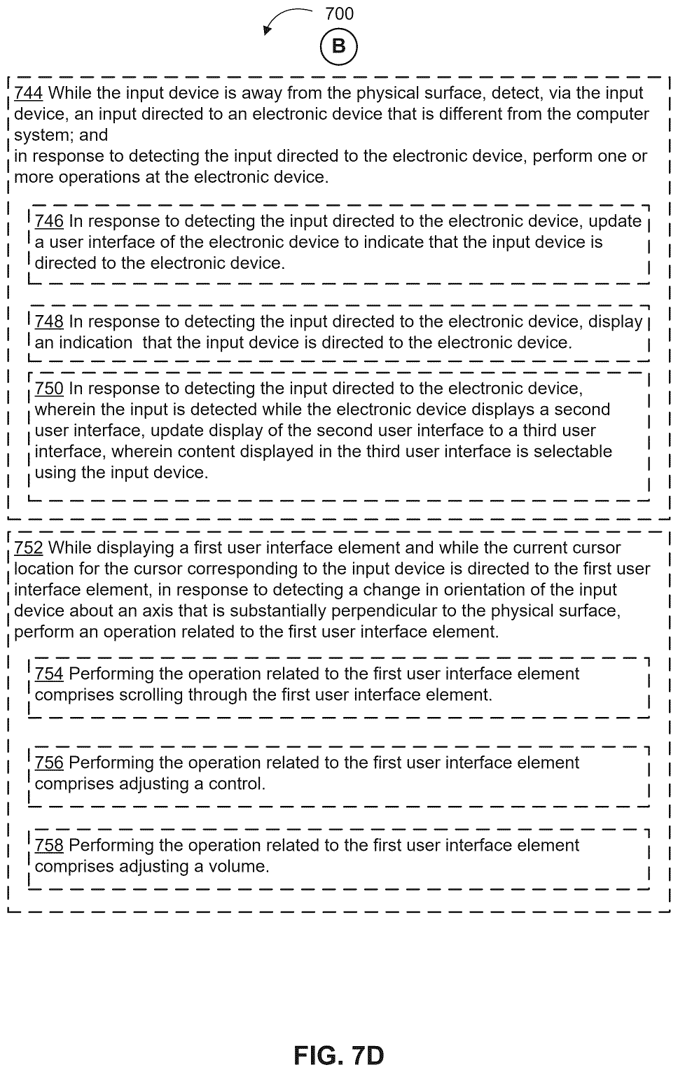

Below, FIGS. 1A-1B, 2, and 3A provide a description of example devices. FIGS. 3B-3G describe the use of Application Programming Interfaces (APIs) to perform operations. FIGS. 4A-4B, FIGS. 5A-5C illustrate an example input device for providing inputs and FIGS. 5D-5AL illustrate example user interfaces based on inputs detected by an input device in accordance with some embodiments. FIGS. 6A-6F illustrate a flow diagram of a method of detecting movements of an input device and moving a cursor and/or performing a system operation in accordance with the detected movements. FIGS. 7A-7D illustrate a flow diagram of a method of moving a cursor based on movements of an input device relative to a physical surface. The input devices and user interfaces in FIGS. 5A-5AL are used to illustrate the processes in FIGS. 6A-6F and 7A-7D.

### Example Devices

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

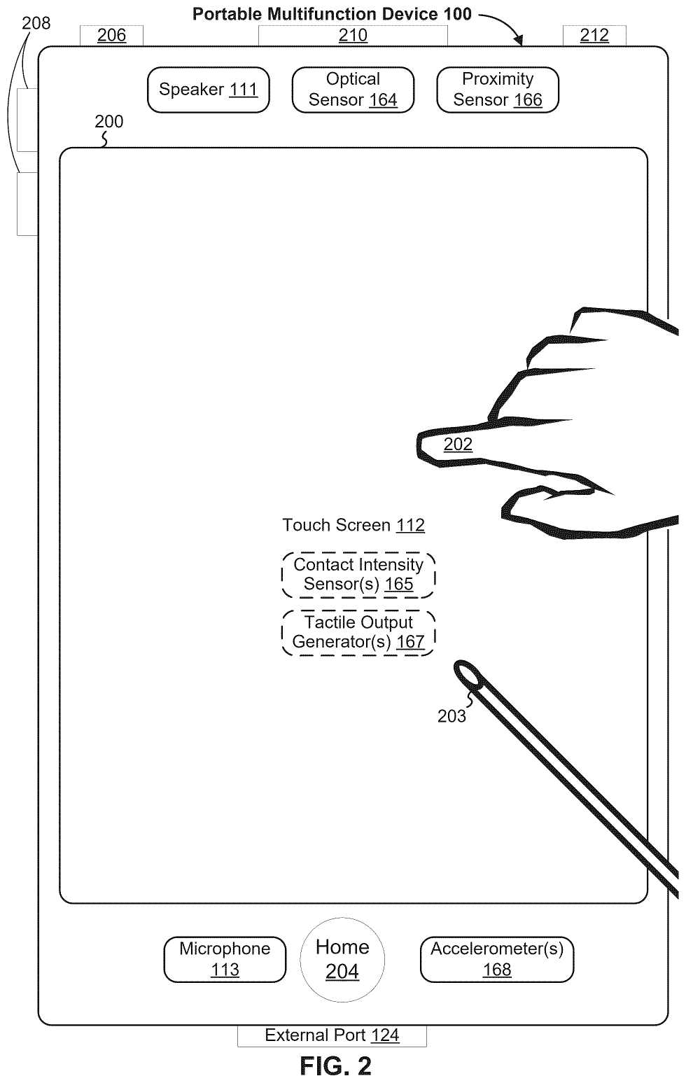

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's car (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, e-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (arc) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call docs), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 600 (FIGS. 6A-6F) and/or method 700 (FIGS. 7A-7D) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Many of the examples that follow will be given with reference to a device that detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to an input device (e.g., a mouse based input or a stylus input), it should be understood that, in some embodiments, one or more of the inputs are replaced with finger inputs (e.g., finger contacts, finger tap gestures, finger swipe gestures, etc.). For example, a mouse click followed by movement of the cursor along the path is, optionally, replaced with swipe gesture or other movement of a contact. As another example, a mouse click while the cursor is located over the location is, optionally, replaced with a tap gesture of the tap gesture (e.g., detection of the contact followed by ceasing to detect the contact). Similarly, when computer mice are, optionally, used simultaneously, it should be understood that multiple user inputs are simultaneously detected, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

### User Interfaces and Associated Processes

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5C illustrate an example input device 500 in accordance with some embodiments. FIGS. 5D-5AL illustrate example user interfaces provided in response to inputs detected via an input device, in accordance with some embodiments. The user interfaces in these figures are used to illustrate the processes described below, including the processes in FIGS. 6A-6F, and 7A-7D. Although some of the examples which follow will be given with reference to inputs on a touch-sensitive surface 451 that is separate from the display 450, in some embodiments, the device detects inputs on a touch-screen display (where the touch-sensitive surface and the display are combined), as shown in FIG. 4A. However, analogous operations are, optionally, performed on a device with a touch-sensitive display system 112.

FIGS. 5A-5C illustrate an example input device 500. In some embodiments, input device 500 operates as a mouse for a computer system that is in communication with a display. For example, while input device 500 operates as a mouse, moving the input device 500 (e.g., across a surface) causes a position of a cursor corresponding to the input device 500 to update (e.g., on a display of the computer system to which input device 500 provides inputs). In some embodiments, input device 500 comprises a symmetrical shape, such as a rounded and/or circular body. In some embodiments, the shape and/or size of input device 500 is configured to be gripped by a hand of a user. For example, the input device 500 has a shape and/or a size such that a user is enabled to lift, rotate, tilt and/or otherwise move the input device 500 both on a surface and in the air (e.g., lifted away from a surface). In some embodiments, input device 500 is configured symmetrically such that a “front” portion of the input device 500 is dynamically determined (e.g., by the computer system) according to a detected position and/or location of the input device 500 relative to the display. For example, the user grabs the input device 500 at any orientation and the computer system dynamically determines which portion of the input device 500 is facing towards the display (e.g., and/or the computer system or other device that the input device 500 controls) as the front of the input device. In some embodiments, a y-axis is defined as substantially perpendicular to the surface on which the input device 500 is moving (e.g., typically along the gravitational axis of the earth); the x-axis is substantially parallel to the surface (e.g., left to right and optionally parallel to the display); and the z-axis is perpendicular to both the x and y axes (e.g., generally forward and backward relative to the display). Rotation about these axes can be described as yaw (about the y-axis), roll (about the z-axis); and pitch (about the x-axis).

In some embodiments, input device 500 is configured to operate across a physical surface (e.g., physical surface 504), for example, as a mouse operating on a table, mousepad, or other surface, and is further configured to operate without touching a physical surface (e.g., in response to a user lifting the input device 500 away from a surface). In some embodiments, the input device 500 is operable about six degrees of freedom (e.g., while lifted away from a surface), such that movement about a respective axis causes a respective operation to be performed. For example, movement of the input device 500 about a first axis causes the input device to control a cursor in a first manner or otherwise perform a first operation, and movement of the input device 500 about a second axis causes the input device to control a cursor in a second manner or otherwise perform a second operation, as described with reference to FIGS. 5D-5AL.

In some embodiments, input device 500 is wirelessly connected to the computer system and/or is connected by wire. For example, although the examples described herein illustrate the input device 500 with a wire (e.g., to connect to the computer system), in some embodiments, input device 500 does not include a wire, cable, or cord.

FIGS. 5D-5AL illustrate example user interfaces that are updated based on inputs detected by the input device 500 in accordance with some embodiments. FIG. 5D illustrates a display 502 that displays a plurality of application windows, including application window 510a, application window 510b and application window 510c. In some embodiments, application window 510a, application window 510b and application window 510c are associated with different applications that are executed by the computer system that is coupled to display 502. In some embodiments, a same application is associated with two or more different application windows. The display 502 further displays a system user interface 514, such as a desktop, a home user interface, a system settings user interface, or another type of system user interface (e.g., the system user interface 514 is displayed behind application windows 510, 510b and 510c). In some embodiments, the display includes a control bar 508 that optionally displays status information, such as a time, a battery level, wireless connectivity information and/or one or more control options for the computer system that is communicatively coupled to display 502. In some embodiments, the control bar 508 further includes information about a currently selected application (e.g., the application that is most recently opened and/or interacted with by the user) and/or includes one or more menus for performing actions for the currently selected application. In some embodiments, the application window corresponding to the currently selected application is displayed in the foreground of the user interface of display 502. For example, while the currently selected application corresponds to the application window 510a, application window 510a is displayed in front of (e.g., without being occluded by) the other open and/or active application windows 510b and 510c.

FIG. 5D illustrates a representation of a cursor 506a that is optionally displayed in the user interface 501 of display 502. In some embodiments, a position of cursor 506a is controlled by movement of the input device 500 (e.g., as a mouse controlling the position of cursor 506a). For example, in some embodiments, input device 500 is positioned on a physical surface 504 such that lateral movement (e.g., along an x-axis and/or z-axis that is defined as substantially parallel to the physical surface 504) across the physical surface 504 causes the cursor 506a to move within the user interface displayed on display 502. In some embodiments, the physical surface 504 is a flat surface, such as a table, a mousepad, a floor, or another surface. In some embodiments, the physical surface 504 corresponds to plane along the x-axis and a z-axis (e.g., a flat surface corresponding to the xz plane). As described herein, the x-axis is substantially parallel to the display 502 and the z-axis is substantially perpendicular to the display 502. It will be understood that movement along the z-axis includes movement closer to and/or away from the display 502, while movement along the x-axis includes side movements (e.g., left and/or right movements) of the input device 500.

For example, as illustrated in FIG. 5E, in response to movement of the input device 500 across the physical surface 504 (e.g., that causes the input device 500 to move along the x-axis and/or z-axis) (e.g., without detecting a tilt or rotation movement around a z-axis that runs through a middle portion of the input device 500 and/or vertical movement along a y-axis that is substantially perpendicular to the physical surface 504), the position of the representation of the cursor 506a displayed in user interface 501 is moved in accordance with the movement of the input device 500. In some embodiments, the cursor 506a moves across the display 502 in two-dimensions (e.g., treats display 502 as a flat surface without a depth component) while the input device 500 is detected on the physical surface 504. For example, the representation of the cursor 506a is displayed as moving to the right and up in response to the movement of the input device 500 to the right and towards the display 502.

In some embodiments, while the cursor 506a is at a position corresponding to content that is displayed within application window 510a, the computer system detects a change in orientation of the input device 500. For example, the change in orientation comprises rotating (e.g., clockwise and/or counterclockwise) the input device 500 about the y-axis that is substantially perpendicular to the physical surface. In some embodiments, as the input device 500 is rotated about the y-axis, the “front” portion of the input device 500 is optionally dynamically redefined as being the portion of the input device 500 that is currently facing the display 502 (e.g., after the rotation). As such, lateral movement along the xz plane after rotating the input device 500 causes the position of the cursor 506a to update in the same manner described with reference to FIG. 5E, without requiring the user to undo the rotation or otherwise identify the “front” portion of the input device 500 that was initially defined in FIG. 5E.

In some embodiments, in accordance with a determination that the cursor 506a is at a position that overlays the content displayed within application window 510a, in response to the change in orientation (e.g., rotation about the y-axis) of the input device 500, the computer system displays one or more control options for the application associated with application window 510a (e.g., to control the content that is displayed at the position corresponding to the position of the cursor 506a). For example, in some embodiments, as soon as the orientation is adjusted, the one or more control options are displayed as newly displayed icons “1” and “2” that are displayed at positions proximate to the current location of cursor 506a (e.g., optionally while concurrently displaying the cursor 506a or without displaying the cursor 506a). For example, the icons “1” and “2” include application-related options for performing one or more functions or otherwise controlling the content of the application corresponding to application window 510a. For example, the application-related options represented by icons “1” and “2” include controls for updating display of the content 512 (e.g., to display the content with different properties). For example, if the application window 510a corresponds to a word processing application, the computer system displays icons that indicate control options for modifying text in the application window 510 (e.g., highlight, bold, increase and/or decrease in size, change a font, change a font size, or other control options). For example, if the application window 510a corresponds to a photos application, the computer system displays icons that indicate control options for modifying and/or sharing the selected photo, like changing the color, transparency, zooming in our out, cropping, toggling between styles, adjusting brightness, exposure, etc. For example, if the application window 510a corresponds to a web browser, the computer system displays icons that indicate control options for copying a URL, sharing, highlighting, and/or otherwise interacting with content displayed in the web browser. It will be understood that other types of applications optionally provide different control options that are based on the type of application and/or that are based on the respective content in the application window that is selected by the cursor 506a at the time the input device 500 is detected to have changed orientation.

In some embodiments, icon “1” is selected in response to detecting the movement illustrated in FIG. 5F (e.g., the change in orientation by a first amount like a rotation of the device on the surface about the y-axis (otherwise known as yaw) by a first amount). In some embodiments, the currently selected icon is displayed with visual emphasis relative to the other icons. For example, icon “1” is displayed with a border, highlighted, enlarged, displayed with additional luminance, or otherwise displayed as visually emphasized relative to icon “2.” In some embodiments, the computer system detects additional movement of the input device 500, for example, in response to the user rotating the input device 500 by a second amount. In some embodiments, in response to detecting the movement of the input device 500 by the second amount, the computer system updates the one or more control options by displaying icon “2” as the currently selected icon (e.g., where icon “2” is displayed with the visual emphasis and icon “1” is no longer displayed with the visual emphasis) and displaying an additional icon “3” as another control option, if available. In some embodiments instead of or in addition to displaying the icons, display objects indicative of the control may be displayed, e.g., a different font and font name, a different style, a different color, etc. In some embodiments, the controls change as the orientation is changed, but no icons are displayed. In some embodiments, the control is not selected until a user clicks the mouse or performs another selection input to cause the change of the control. For example, additional icons, if available, are displayed in response to the user continuing to rotate the input device by greater amounts, as if to scroll through the icons. As such, the computer system scrolls through one or more control options (e.g., and optionally displays additional control options) as the input device 500 changes in orientation (e.g., rotation about the y-axis) by different amounts. For example, rotating the input device 500 by the first amount causes icon “1” to be selected; rotating the input device 500 by the second amount (e.g., relative to its initial position in FIG. 5E) (e.g., where the rotation by the second amount is achieved by a continuous input and/or by one or more successive inputs in which the input device 500 continues to be moved by more and more) causes icon “2” to be selected, and rotation by a third amount that is greater than the first and second amounts causes icon “3” to be selected.

In some embodiments, the icons “1” “2” and “3” are displayed as an arch (e.g., a semicircle) around the position of the cursor 506a. In some embodiments, a maximum number of icons (e.g., 2, 3, 4 or another number) are displayed concurrently. For example, in response to additional rotation of the input device 500, icons “2” “3” and “4” are displayed and icon “1” ceases to be displayed. In some embodiments, icons “2” and “3” shift in position to maintain the semicircle created by the icons (e.g., as illustrated in FIGS. 5K-5L). In some embodiments, the representation of the cursor 506a is optionally not displayed while the icons are displayed.

In some embodiments, as illustrated in FIG. 5G, in response to detecting icon “2” is selected (e.g., by rotating the input device 500 to select icon “2”), the content displayed in application window 510a is updated (e.g., as illustrated by the shaded patten of the content in FIG. 5F versus the content in FIG. 5G), representing a modification to the content in response to selection of the icon “2” for a control option. In some embodiments, the computer system ceases display of the one or more control options in response to detecting another type of input (e.g., that does not correspond to a change in orientation of the input device 500), for example a click input and/or lateral movement of the input device 500 causes the computer system to cease display of the icons “1”, “2”, and “3”.

In some embodiments, the icons are displayed as options in a list of options, such that a change in orientation of the input device 500 causes the computer system to scroll through the list of options. For example, rotating the input device 500 by a small amount scrolls to the first option in the list (e.g., icon “1”), and continuing to rotate the input device by a larger amount scrolls to another option farther down the list (e.g., to icon “2” or icon “3” depending on the amount, where a larger amount of rotation is used to scroll to icon “3” than the amount of rotation used to scroll to icon “2”). In some embodiments, rotating the input device at a low speed scrolls to the first option in the list (e.g., icon “1”) and rotating the input device at a higher speed scrolls to another option farther down the list (e.g., to icon “2” or “3” depending on the speed, where faster speed is used to scroll to icon “3” than the speed used to scroll to icon “2”). In some embodiments, a series of inputs causes the change in orientation of the input device to change over time, such that, as the user continues rotating or otherwise changing the orientation by a different magnitude, different options in the list are displayed and/or selected in accordance with the series of inputs. For example, multiple inputs (e.g., distinct rotations and/or inputs with varying speeds) are used to scroll from icon “1” to icon “2” and/or icon “3”. In some embodiments, a single, continuous input is used to scroll from icon “1” to icon “2” and/or icon “3” (e.g., a single input that increases the amount of rotation of input device 500 over time causes the computer system to scroll from icon “1” to icon “2” and to icon “3”), and optionally provides an audio, haptic and/or visual output to indicate when the movement of the input device 500 has caused the computer system to scroll to the next icon.

In some embodiments, the user optionally continues to operate the input device 500 as a conventional mouse while the input device 500 is on the physical surface 504. For example, in FIG. 5H, the input device 500 moves across the physical surface 504, and in response to detecting the input device 500 laterally moving across the physical surface, the current position of the cursor 506a is updated (e.g., to move down and to the right), and the representation of the cursor 506a is displayed as moving, in accordance with the detected movement of the input device 500.

FIG. 5I illustrates another embodiment where, while the position of the cursor 506a is over a system user interface 514, such as the desktop displayed behind the application windows 510a, 510b and 510c, the computer system detects the input device 500 changing orientation (e.g., a counterclockwise or clockwise rotation) about the y-axis. In some embodiments, the change in orientation is a rotation in a second direction (e.g., counter-clockwise yaw) that is opposite to the change in orientation described below with reference to FIG. 5J (and optionally the opposite to the change in orientation described with reference to FIGS. 5F and 5G). In some embodiments, in response to detecting the change in orientation in the second direction, the computer system forgoes displaying one or more control options. For example, rotating the input device in one direction, but not another, causes the computer system to display one or more control options (e.g., selected based on a current cursor location in the user interface) while rotating the input device in the other direction does not cause the computer system to display the one or more control options. In some embodiments, rotating the input device in the second direction causes the computer system to display a different set of options than the set of control options displayed in response to detecting rotation of the input device in the first direction. For example, a clockwise yaw may alter the text content's font, while a counter-clockwise yaw may change the font size. In some embodiments, the control options that are displayed or not displayed are based on the position of the cursor 506a (e.g., a different set of control options are displayed while the cursor 506a is positioned over application content rather than the system user interface 514). In some embodiments, a position of the cursor does not affect the control options, e.g., any yaw of the input device 500 (e.g., irrespective of whether the cursor is on a window or the desktop) will toggle through system controls. In some embodiments the control options are contextual, e.g., if the computer system is playing music, then yaw of the mouse will adjust the volume of the music.

FIG. 5J illustrates that, while the position of the cursor 506a is over system user interface 514 (e.g., and/or is determined as not being over an application window), the computer system detects a change in orientation of the input device 500 (e.g., a rotation about the y-axis while the input device is touching the physical surface 504), and in response to detecting the change in orientation of the input device 500 (e.g., in the first direction, for example, counter-clockwise), the computer system displays one or more system control options as icons “A” and “B”. In some embodiments, the one or more system control options are different from the one or more control options displayed for the respective application corresponding to application window 510a described with reference to FIG. 5F.

In some embodiments, displaying the one or more system control options includes displaying a multitasking view in which representations (e.g., application icons, thumbnails, or other representations) of recently opened applications are displayed around the current position of the cursor 506a. For example, icons “A”, “B”, and “C” represent different applications. For example, the icon for application A corresponds to application window 510a, the icon for application B corresponds to application window 510b, and the icon for application C corresponds to application window 510c. As such, the user is enabled to scroll or toggle between the different icons and their associated application windows, by changing the orientation about the y-axis (e.g., rotating) the input device 500 by varying amounts. In some embodiments, the application window corresponding to the currently selected icon is selected such that the application window is moved to the foreground of the user interface (e.g., in front of other open application windows that are displayed). In other embodiments, changing the orientation, e.g., rotation about the y-axis, toggles between the displayed windows without displaying the icons.

In some embodiments, the one or more system control options includes performing one or more system operations other than multitasking. For example, the one or more system control options include modifying one or more settings for the computer system, such as brightness, volume (e.g., controlling the volume of a wirelessly connected smart speaker), and/or connectivity options.

In some embodiments, as illustrated in FIG. 5K, in response to detecting additional rotation of input device 500 about the y-axis (e.g., in the clockwise direction), icon “B” is selected and icon “C” is displayed. While icon “B” is selected, application window 510b corresponding to application icon “B” is displayed in the foreground of the user interface of display 502. Displaying an application window in the foreground is also referred to as the application window being in-focus.

As illustrated in FIG. 5L, in response to detecting an additional rotation of input device 500 about the y-axis (e.g., in the clockwise direction), icon “C” is selected, icon “D” is displayed and previously displayed icon “A” is no longer displayed (e.g., icon “A” has been scrolled out of view). As such, as the user rotates the input device 500 in the same direction, additional icons are scrolled through (e.g., in the multitasking view). In some embodiments, while icon “C” is selected, the application window 510c corresponding to application icon “C” is displayed in the foreground of the user interface of display 502 (e.g., application windows 510a and 510b are displayed as at least partially occluded by application window 510c). For example, the multitasking view causes the computer system to display the application window corresponding to the currently selected icon in the foreground of the user interface 501 to enable the user to quickly switch between application windows for different applications.

In some embodiments, as the user rotates or otherwise changes orientation of the input device 500, one or more haptic outputs are generated by input device 500, e.g., a detent or a bump is felt for each selection. For example, as the user scrolls through icons A-D, for each additional rotation that causes the currently selected icon to change, a haptic output is generated and output by input device 500. As such, the user is provided with tactile feedback for how much rotation causes the next icon to be selected while the user scrolls through the icons.

In some embodiments, rotation of input device 500 in an opposite direction causes the computer system to scroll backwards through the icons, as illustrated in FIG. 5M. For example, in response to detecting a rotation of input device 500 about the y-axis in the opposite direction (e.g., in the counterclockwise direction), icon “B” is selected and application window 510b is again displayed in the foreground of the user interface. As such, the user is enabled to quickly switch, via the multitasking view, between recently open applications in order to bring a selected application window to the foreground.

FIG. 5N illustrates detecting movement of the input device 500 (e.g., lateral movement along the x-axis and/or the z-axis corresponding to the physical surface), and in response to detecting the movement, the computer system ceases display of the multitasking view, and maintains the application window 510b (e.g., as the selected application icon “B”) in the foreground of the user interface, as illustrated in FIG. 5N.

FIG. 5O illustrates that, while the position of the cursor 506a is at a location that corresponds to (e.g., overlaps in position with or otherwise selects) application window 510b, in response to detecting a change in orientation of input device 500, a set of control options for application window 510b is displayed, including icons “X” and “Y.” For example, in response to detecting first movement (e.g., a change in orientation by a first amount) about the y-axis in FIG. 5O, icon “X” is selected, and in response to detecting second movement (e.g., a change in orientation by a second amount) about the y-axis (e.g., in the same direction as the first movement), the icon “Y” is selected, as illustrated in FIG. 5P. As described with reference to FIG. 5F, the control options corresponding to the icons “X” and “Y” are determined based on the application corresponding to application window 510b. In some embodiments, where only two control options are available for application window 510b, the computer system does not display additional control options, even as the input device 500 continues to change in orientation.

FIG. 5Q illustrates the computer system detecting the input device 500 as lifted away from the physical surface 504. For example, the input device 500 is raised above the physical surface 504 (e.g., along the y-axis perpendicular to the physical surface 504) to create a distance d1 between the input device 500 and the physical surface 504. In some embodiments, in response to detecting the input device 500 as being lifted away from the physical surface 504, the computer system displays the representation of the cursor 506b as a three-dimensional cursor, optionally with a shadow that follows the representation of the cursor 506b.

In some embodiments, the representation of the cursor 506b appears as lifted off of the application windows 510 displayed in the user interface 501. For example, the representation of the cursor 506b appears closer to the user than application window 510b with a non-zero distance between the representation of the cursor 506b and application window 510b, as though the representation of the cursor 506b is lifted off of the plane of application window 510b. In some embodiments, in response to detecting movement of the input device 500 that causes movement of the representation of the cursor 506b, the cursor 506b appears as going into the display, as described below with reference to FIG. 5R.

In some embodiments, the computer system detects (e.g., while the input device 500 is lifted off and/or not touching the physical surface 504) movement of the input device 500 about six degrees of freedom, including rotation of the input device 500 about the y-axis (e.g., clockwise and/or counterclockwise rotation), tilt (e.g., and/or rotation) of the input device about the z-axis (e.g., tilting side-to-side relative to the display 502), and tilt (e.g., and/or rotation) of the input device about the x-axis (e.g., tilting forward-to-back relative to the display 502). Further, the computer system continues to detect lateral movement of the input device 500 across the x-axis and z-axis, as well as vertical movement across the y-axis (e.g., increasing and/or decreasing a distance between the input device 500 and physical surface 504).

In some embodiments, the three-dimensional representation of the cursor 506b is also displayed as moving about six degrees of freedom in the user interface of display 502. For example, movement along the y-axis creates additional distance between the physical surface 504 and the input device 500, as indicated by distance d2, and causes the cursor to move up in the display 502, movement of the input device 500 along the x-axis (e.g., to the right) causes the position of the cursor 506b to move to the right, and movement of the input device along the z-axis causes the position of the cursor 506b to move farther into the display (e.g., in depth).

For example, as illustrated in FIG. 5R, the cursor 506b is displayed as pointing into the user interface (e.g., past application window 510b), as directed to application window 510a. In some embodiments, the representation of the cursor 506b is displayed as moving along the z-axis (e.g., into the displayed user interface 501 and/or lifted off the displayed user interface 501) in response to detecting selection user inputs. For example, selecting application window 510a as being in-focus by moving the current location of the cursor 506b over the application window 510a and/or by selecting application window 510a via a selection input (e.g., a tap input or other selection input) while the current location of the cursor 506b is over the application window 510a causes the representation of the cursor 506b to move, along the z-axis, to appear farther away than the application window 510b and closer than the application window 510a. In some embodiments, the representation of the cursor 506b is displayed as moving towards the selected application window 510a. As such, the user interface 501 is displayed with a three-dimensional effect in which the representation of the cursor 506b can travel in depth while selecting various application windows and/or content that are displayed to appear at different depths within the three-dimensions.

FIG. 5S illustrates detecting the input device 500 lifted off the surface (e.g., to d2) and being tilted to its side, e.g., rotated about the z-axis. In some embodiments, the input device 500 is moved closer to the physical surface 504 (e.g., to a distance from d2 to d3) and the cursor 506b is displayed as moving down in the user interface 501. In some embodiments, in response to detecting the input device 500 has tilted by at least a threshold amount of tilt (e.g., a threshold angle of rotation about the z-axis), the computer system performs a multitasking operation that includes displaying open application windows 510a, 510b and 510c having a perspective or side view. For example, while the application windows 510a, 510b and 510c are displayed with a perspective or side view, the user can easily navigate between the open application windows to select a respective application window to bring to the foreground of the user interface 501. In some embodiments, in response to detecting the input device 500 as tilting to its side about the z-axis, a different system operation is performed, such as controlling one or more system settings and/or displaying a system user interface.

FIG. 5T illustrates that, while the input device 500 continues to be tilted to its side about the z-axis, the user can move the input device (e.g., and/or a front portion of the input device) from left to right, along the x-axis that is substantially parallel to the display 502 and surface to cause the current location of cursor 506b to update. In some embodiments, the current location of cursor 506b that overlaps a respective application window causes that respective application window to be the in-focus application window. In some embodiments, the in-focus application window (e.g., the application in the foreground) is visually emphasized relative to the other application windows displayed in the side view. For example, by moving the input device 500 left to right and/or in another manner, while input device 500 continues to be tilted to its side, the cursor 506b moves to overlap different application windows, and while a respective application window is in-focus (e.g., corresponds to the current cursor 506b location), the respective application window is increased in size, increased in luminance, highlighted and/or otherwise displayed with greater prominence relative to the other application windows that are not currently in-focus. In some embodiments, while a respective application window is in-focus, the respective application window is visually emphasized by visually deemphasizing (e.g., dimming, blurring, decreasing in size, decreasing in luminance and/or otherwise displaying with less prominence) the other application windows that are not currently in-focus.

In some embodiments, the current location of the cursor 506b overlaps with application window 510c, and in response to detecting the input device 500 reversing the tilt to its side about the z-axis, application window 510c is selected as the in-focus application window to be displayed in the foreground of the user interface (e.g., and is optionally displayed with an increased size after selection by the user).

In some embodiments, as illustrated in FIGS. 5U-5X, the application window 510c includes a three-dimensional object 516. In some embodiments, while the current cursor 506b is located at a position that corresponds to the three-dimensional object 516, the input device 500 is enabled to control movement of the three-dimensional object 516 about multiple degrees of freedom of the input device 500 (e.g., all six degrees of freedom). For example, the three-dimensional object 516 is displayed as changing orientation within the application window 510c in the user interface 501.

For example, in FIG. 5V, the input device 500 is moved to tilt about the z-axis and change orientation about the y-axis, and in response to detecting the movement of the input device 500 while the cursor 506b is positioned over the three-dimensional object 516, the three-dimensional object 516 is displayed as moving or rotating about the z-axis and changing orientation about the y-axis in accordance with the detected movement of the input device 500. As such, the three-dimensional object 516 is displayed as tracking the movements of the input device 500. In some embodiments, the amount of movement of the three-dimensional object is scaled by a factor (e.g., 0.5×, 1.5×, 2×, or another factor) relative to the amount of movement of the input device 500. For example, a change in orientation and/or tilt of the input device 500 causes a greater and/or lesser amount of change in orientation and/or tilt of the three-dimensional object 516 according to the scaling factor.

FIGS. 5W-5X illustrate additional movements of the input device 500, and in response to detecting the movements of the input device 500, the three-dimensional object 516 is displayed as being updated according to the detected movement, e.g., moved left or right (e.g., along the x-axis), up or down (e.g., along the y-axis), or into or out of the screen (e.g., along the z-axis).

FIG. 5Y illustrates that, in response to a selection input (e.g., a click down, a touch input on input device 500, or another selection input) directed to the three-dimensional object 516, the input device 500 controls movement of the three-dimensional object 516 within the user interface 501. For example, in response to detecting lateral movement of the input device (e.g., after and/or while the three-dimensional object 516 is selected by the selection input), the three-dimensional object 516 is dragged across the user interface 501 in accordance with the detected lateral movement. In some embodiments, instead of detecting lateral movement to drag the three-dimensional object 516 across the user interface 501, in response to detecting a rotation (e.g., about the y-axis) (e.g., clockwise and/or counterclockwise) of the input device 500 (e.g., while the three-dimensional object 516 is selected), causes the computer system to switch the currently selected application window that is displayed in the foreground (e.g., via the multitasking process described with reference to FIG. 5J). For example, the application window 510c is displayed in the foreground while the three-dimensional object 516 is selected, and in response to detecting rotation of the input device 500, application window 510a is displayed in the foreground of the user interface, and three-dimensional object 516 is displayed within application window 510a. As such, the user moves the three-dimensional object 516 from one application window to another application window (e.g., and/or to a system user interface) by rotating and/or changing an orientation of the input device 500.

In some embodiments, the three-dimensional object 516 is moved from application window 510c to application window 510a. In some embodiments, as illustrated in FIG. 5Z, the three-dimensional object 516 is moved to the system user interface 514 or another portion of the user interface 501. For example, dragging the three-dimensional object 516 to the system user interface 514, such as a desktop, causes a representation of the three-dimensional object 516 to be displayed or otherwise stored (e.g., as a file) on the system user interface 514.

In some embodiments, the three-dimensional object 516 is moved in accordance with the detected movement of input device 500 until a release (e.g., deselection and/or end) input is detected. For example, the three-dimensional object 516 is dropped within a respective application window and/or system user interface that the three-dimensional object 516 substantially overlaps at the time the release input is detected. As such, the input device 500 performs a drag-and-drop operation on the three-dimensional object 516.

FIG. 5AA illustrates that the three-dimensional object 516 is moved to be displayed in application window 510a. In some embodiments, as illustrated in FIG. 5AA, the computer system detects vertical movement (e.g., along the y-axis) of the input device 500 such that the input device 500 is touching the physical surface 504 (e.g., from a distance of d3 to no distance between the input device 500 and physical surface 504). In some embodiments, in response to detecting that the input device 500 is touching the physical surface 504, the input device 500 functions as a mouse, such that lateral movements along the x-z plane cause the cursor 506a to move in the user interface 501. For example, while the input device 500 is touching physical surface 504, a click or other selection input via the input device 500 while the location of the cursor 506a is over the three-dimensional object 516 causes selection of the three-dimensional object 516, and in response to detecting lateral movements of the input device 500 while the three-dimensional object 516 is selected, the three-dimensional object 516 is moved in accordance with the lateral movements (e.g., the input device 500 is used to drag or otherwise move the three-dimensional object 516). In some embodiments, the representation of the cursor 506a is displayed as a two-dimensional representation in the user interface 501 while the input device 500 is touching the physical surface 504. In some embodiments, a change in vertical movement of the input device 500, for example, from no distance between the input device 500 and physical surface 504, to a distance such as d3, that is detected while the cursor is overlaying the three-dimensional object 516 causes the three-dimensional object 516 to be selected, and lateral movements of the input device 500 while the input device 500 is not touching the physical surface 504 causes the three-dimensional object 516 to move within the user interface 501 (e.g., the input device 500 is used to drag the three-dimensional object 516) to another position. In some embodiments, in response to detecting vertical movement that causes input device 500 to touch physical surface 504, three-dimensional object 516 is dropped, or otherwise displayed, at the position in the user interface 501 to which it was dragged while the input device 500 was not touching the physical surface.

FIG. 5AB illustrates that, in response to detecting the input device 500 lifting off the physical surface 504 by a distance d4 (e.g., along the y-axis), the cursor 506b is updated to be displayed as a three-dimensional icon, optionally with a shadow. As such, the input device 500 seamlessly switches between operating as a mouse input device (e.g., while on the physical surface 504) and as a pointer input device that operates about six degrees of freedom (e.g., while not on the physical surface 504).

FIG. 5AC illustrates detecting movement of the input device 500 that includes rotation and/or tilt about the z-axis (e.g., such that the input device 500 is held on its side). In some embodiments, as described above with reference to FIG. 5S, the user interface 501 is updated to display open application windows 510a-510c in a side view layout.

In some embodiments, as illustrated in FIG. 5AD, in response to detecting a position of the cursor 506b located at a position corresponding to (e.g., overlapping with or otherwise selecting) control bar 508 displayed in the user interface 501, a plurality of controls are displayed in menu 518, as illustrated in FIG. 5AE. In some embodiments, menu 518 includes a plurality of control options, including controls for WiFi, Bluetooth, and/or other wireless connections for the computer system coupled to display 502, controls for controlling one or more settings, such as a focus mode, a display brightness, a volume, and/or controlling media playback. In some embodiments, menu 518 further includes account information, and/or battery information.

In some embodiments, in response to detecting cursor 506b at a position that corresponds to the sound control in the menu 518, the input device 500 is enabled to modify the volume of the computer system by moving the input device 500 laterally (e.g., left-to-right along the x-axis) and/or by rotating the input device 500 about the y-axis (e.g., similar to turning a knob) to control the slider bar representing the volume level, as illustrated in FIG. 5AF. In some embodiments, the input device 500 controls other system functions, such as a display brightness level, by turning the input device 500 about the z-axis while the cursor 506b is at a position corresponding to the respective control for the respective system function, and moving the input device 500 laterally (e.g., left-to-right along the x-axis) to control respective control for the respective system function. For example, the input device 500 is enabled to control a playback position of media content.

FIGS. 5AG-5AH illustrate, in some embodiments, while the input device 500 is touching the physical surface, the input device 500 causes the computer system to adjust one or more system functions in response to detecting the input device 500 as changing orientation (e.g., rotating about the y-axis). For example, in FIG. 5AH, the display brightness is controlled by the slider bar, and in response to detecting a clockwise rotation of the input device 500, the display brightness is increased (e.g., by an amount proportional to an amount of detected rotation of the input device 500).

FIG. 5AI illustrates in response to detecting a user input that causes the input device 500 to rotate in the direction opposite to the direction illustrated in FIG. 5AH, the display brightness is lowered.

FIG. 5AJ illustrates input device 500 optionally controlling a distinct device, device 2, external to the computer system and device 500, while the input device 500 is on the physical surface. For example, a change in orientation (e.g., rotation clockwise and/or counterclockwise about the y-axis) of the input device 500 causes one or more properties (e.g., system properties) of device 2 to change in accordance with the change in orientation of the input device 500. In some embodiments, device 2 is a distinct computer system that is communicatively coupled to the computer system. For example, device 2 and the computer system are logged into a same account and/or or wirelessly paired. In some embodiments, device 2 comprises a tablet, a phone, an external monitor, a speaker, a laptop, or another type of electronic device. In some embodiments, device 2 does not include a display. For example, while device 2 is a speaker that does not include a display, the volume of the speaker is updated in accordance with the change in orientation of the input device 500. In some embodiments, an indication, such as a light or other visual and/or audio indication, is output by device 2 to indicate that device 2 is being controlled by the input device 500. In some embodiments, the input device 500 switches between controlling device 2 and controlling the computer system via a user input (e.g., a sequence of inputs and/or gestures detected at input device 500).

FIG. 5AK illustrates displaying user interface 501 without displaying a representation of a cursor. In some embodiments, the user interface 501 is updated in response to detecting that the input device 500 is not touching the physical surface (e.g., the input device 500 has been lifted off the surface). In some embodiments, while the input device 500 is detected as not touching the physical surface, the user interface 501 is displayed in a media-navigation mode of display such that content and/or application windows are selectable without displaying a representation of the cursor. For example, the user navigates the user interface 501 in the media-navigation mode by moving the input device 500 (e.g., from side to side and/or up and down) and the display is updated to display the currently selected user interface element (e.g., content, application window, or other object) as visually emphasized (e.g., highlighted, enlarged, with a border, or another visual emphasis) relative to the user interface elements that are not currently selected. As such, the user is aware of the current location of the cursor without the computer system displaying an icon representing the cursor 506b in the user interface 501 (e.g., the representation of the location of the cursor 506b is indicated by visually emphasizing and/or deemphasizing displayed content in the user interface).

FIGS. 5AK-5AL illustrate, in some embodiments, the input device 500 provides inputs to control one or more functions of device 2 while the input device 500 is not touching the physical surface. For example, in response to detecting the input device 500 as tilting to its side (e.g., about the z-axis) optionally while input device 500 is pointing toward device 2, input device 500 is used to control device 2 (while input device 500 remains tilted) by moving the input device laterally, for example, to increase and/or decrease a volume or perform another operation at device 2. In some embodiments, while the operation is being performed at device 2, optionally an LED or other light of device 2 flashes (e.g., if device 2 does not have a display to display an indication that device 2 is being controlled by input device 500). In some embodiments, another type of indication, such as visual indication, and audio indication and/or a haptic indication is output via device 2 and/or input device 500 to indicate that input device 500 is controlling device 2.

FIGS. 6A-6F are flow diagrams illustrating method 600 of detecting movements of an input device and moving a cursor and/or performing a system operation in accordance with the detected movements, in accordance with some embodiments. Method 600 is performed at a computer system (e.g., device 300, FIG. 3A, or portable multifunction device 100, FIG. 1A) in communication with a display generation component and an input device (e.g., a mouse that is also a pointer device or another external input device). In some embodiments, the display generation component is a touch-screen display. Some operations in method 600 are, optionally, combined and/or the order of some operations is, optionally, changed.

Method 600 provides a system controlled by an input device whereby lateral movement of the input device causes a cursor to move in accordance with the lateral movement and a change in orientation of the input device causes a system operation to be performed. Thus, method 600 enables the user to access additional system controls and perform system operations without displaying additional controls and without the need for the user to provide additional inputs to navigate complex user interfaces (e.g., with multiple user interface elements across multiple hierarchy levels), thereby reducing the number, complexity, and extent of user inputs.

The computer system, while displaying (602), via the display generation component, a first user interface, while a current cursor location for a cursor corresponding to the input device is at a first location of the first user interface: in response to detecting first movement of the input device (604): in accordance with a determination that the first movement includes lateral movement of the input device relative to a physical surface that the input device is touching (e.g., resting on or moving on) (e.g., movement along an axis that is substantially parallel to the surface), updates (606) display of the cursor as moving (e.g., to a second location of the first user interface) based on the lateral movement of the input device on the physical surface. In some embodiments, the cursor is displayed at the current cursor location. In some embodiments, the cursor is not displayed at the current cursor location but when a cursor display event occurs (e.g., a click, press, move or tap input), the cursor is displayed at the current cursor location. For example, in FIG. 5D, the representation of cursor 506a is displayed in the user interface 501. In some embodiments, the cursor is moved, on the display, with a speed and/or direction corresponding to a speed and/or direction of the movement of the input device. For example, as described with reference to FIGS. 5D-5E, in response to movement of input device 500 along the xz plane (e.g., on the surface 504), the representation of cursor 506a is updated as moving in the user interface 501, in accordance with the lateral movement of input device 500 along the xz plane.

The computer system, while displaying (602), via the display generation component, a first user interface, while a current cursor location for a cursor corresponding to the input device is at a first location of the first user interface: in response to detecting first movement of the input device (604): in accordance with a determination that the first movement includes a change in orientation of the input device (e.g., a change in orientation relative to the physical surface or relative to an axis that is perpendicular to the physical surface such a tilt of a vertical axis of the device relative to an vector normal to the physical surface that the input device is in contact with or such as rotational movement about a vertical axis of the input device), performs (608) a system operation that is determined based at least in part on an amount of the change in orientation of the first movement. For example, in accordance with a determination that the change in orientation of the first input device is by a first amount that satisfies a first threshold, the computer system performs a first system operation; and in accordance with a determination that the change in orientation of the first input device is by a second amount that satisfies a second threshold, different from the first threshold, the computer system performs a second system operation different from the first operation) For example, as described with reference to FIGS. 5J-5M, in response to detecting a rotation about the y-axis of input device 500 (e.g., while the cursor is at a location that corresponds to a system user interface 514), a system operation, such as a multitasking operation, a system volume change operation, or another system-based operation, is performed, where icons representing options for performing the system operation are displayed based at least in part on the amount of rotation of the input device 500.

In some embodiments, performing the system operation that is determined based at least in part on an amount of the change in orientation of the first movement comprises (610) displaying an application switching view that displays a plurality of representations of applications that correspond to recently open applications (e.g., a multitasking view for viewing representations of applications that are currently executing, for example in the background, of the computer system and/or have been recently viewed and/or opened). For example, as described with reference to FIGS. 5J-5M, in response to detecting a rotation about the y-axis of input device 500, a multitasking operation is performed in response to the change in orientation (e.g., rotation about the y-axis) of input device 500. Performing a multitasking operation in response to a change in orientation of the input device reduces the number of inputs needed to switch between recently used and/or open application windows.

In some embodiments, while the current cursor location is at a second location of the first user interface (e.g., different from the first location), in response to detecting second movement of the input device (612): in accordance with a determination that the second movement includes lateral movement of the input device relative to the physical surface that the input device is touching (e.g., resting on or moving on) (e.g., movement along an axis that is substantially parallel to the surface), the computer system updates display of the cursor as moving (e.g., to a second location of the first user interface) based on the lateral movement of the input device on the physical surface; and in accordance with a determination that the second movement includes a change in orientation of the input device (e.g., a change in orientation relative to the physical surface or relative to an axis that is perpendicular to the physical surface such a tilt of a vertical axis of the device relative to an vector normal to the physical surface that the input device is in contact with or such as rotational movement about a vertical axis of the input device), the computer system performs an operation associated with content that is displayed at the second location of the first user interface (e.g., a contextual operation is performed for an application window, application content, system content and/or other content that is displayed in the first user interface at the second location where the current location is located while detecting the second movement of the input device). For example, as described with reference to FIGS. 5F-5G, in response to detecting a rotation about the y-axis of input device 500 while the current location of cursor 506a corresponds to content 512 in application window 510a, an operation related to content 512 is performed (e.g., options for updating and/or interacting with content 512 are displayed as icons “1” “2” and “3”). Moving a cursor in accordance with detected lateral movement of an input device and performing a context-dependent operation in accordance with a change in orientation of the input device based on the context of where the current cursor location is located at the time of the change in orientation reduces the number of inputs needed to perform operations when respective contextual circumstances are met.

In some embodiments, the first location of the first user interface corresponds to (614) a system user interface of the computer system (e.g., a desktop, a system application window, a system control (e.g., volume, brightness, and/or other menu of controls options)) displayed in the first user interface and performing the system operation that is determined based at least in part on an amount of the change in orientation of the first movement comprises displaying an application switching view that displays a plurality of representations of applications that correspond to recently open applications (e.g., a multitasking view for viewing representations of applications that are currently executing, for example in the background, of the computer system and/or have been recently viewed and/or opened). For example, as described with reference to FIGS. 5J-5M, in response to detecting a rotation about the y-axis of input device 500 while the current location of cursor 506a corresponds to a system user interface 514, a multitasking operation or other system operation is performed in response to the change in orientation (e.g., rotation about the y-axis) of input device 500. In some embodiments, while the current cursor location is at a location corresponding to an application user interface (e.g., different from the system user interface corresponding to the first location) displayed in the first user interface, in response to detecting third movement of the input device: in accordance with a determination that the third movement includes a change in orientation of the input device, the computer system performs an operation for an application (e.g., different from the system operation) corresponding to the application user interface displayed in the first user interface at the current cursor location. In some embodiments, the operation for the application is determined based at least in part on an amount of the change in orientation of the third movement. In some embodiments, in response to detecting third movement of the input device and in accordance with a determination that the third movement includes lateral movement of the input device relative to a physical surface that the input device is touching (e.g., resting on or moving on) (e.g., movement along an axis that is substantially parallel to the surface), the computer system updates display of the cursor as moving (e.g., to a second location of the first user interface) based on the lateral movement of the input device on the physical surface. In some embodiments, the cursor is moved, on the display, with a speed and/or direction corresponding to a speed and/or direction of the movement of the input device. For example, as described with reference to FIGS. 5F-5G, in response to detecting a rotation about the y-axis of input device 500 while the current location of cursor 506a corresponds to content 512 in application window 510a, an operation related to content 512 is performed. Performing a system operation while the cursor is located over a system user interface or performing an application-specific operation while cursor is located over an application user interface, in response to a change in orientation of the input device enables the user to access system-level and application based control options without displaying additional controls, thereby reducing a number of inputs needed to perform the respective system or application based operation.

In some embodiments, while the current cursor location is at a location corresponding to a respective application user interface displayed in the first user interface, in response to detecting fourth movement of the input device, in accordance with a determination that the fourth movement includes a change in orientation of the input device (616) (e.g., the same type of change in orientation as the first movement and/or a different change in orientation than the first movement): in accordance with a determination that the respective application corresponding to the current cursor location is a first application user interface associated with a first application, the computer system performs a first operation for the first application (e.g., an operation for modifying content of the first application, an operation for controlling one or more functions of the first application, and/or an operation for interacting with the first application). For example, as described with reference to FIGS. 5F-5G, in response to detecting a rotation about the y-axis of input device 500 while the current location of cursor 506a corresponds to content 512 in application window 510a, an operation related to content 512 is performed (e.g., options for updating and/or interacting with content 512 are displayed as icons “1” “2” and “3”). In some embodiments, in accordance with a determination that the respective application corresponding to the current cursor location is a second application user interface associated with a second application, the computer system performs a second operation, different from the first operation for the second application (e.g., an operation for modifying content of the second application, an operation for controlling one or more functions of the second application, and/or an operation for interacting with the second application). In some embodiments, the second operation is a same type of operation as the first operation, but for performing the operation with respect to the second application that is different from the first application). For example, as described with reference to FIGS. 5O-5P, in response to detecting a rotation about the y-axis of input device 500 while the current location of cursor 506a corresponds to application window 510b, an operation related to application window 510b (e.g., and/or content within application window 510b) is performed (e.g., options for updating and/or interacting with application window 510b are displayed as icons “X” and “Y”). Performing a first type of application-specific operation while the cursor is located over a first application user interface or performing a second type of application-specific operation while cursor is located over a second application user interface, in response to a change in orientation of the input device, enables the user to access application based control options for different applications displayed in different application windows, without displaying additional controls, thereby reducing a number of inputs needed to perform the respective application based operation.

In some embodiments, while the current cursor location is at a location corresponding to respective content of a respective application displayed in the first user interface, in response to detecting fifth movement of the input device, in accordance with a determination that the fifth movement includes a change in orientation of the input device (618) (e.g., the same type of change in orientation as the first movement and/or a different change in orientation than the first movement): in accordance with a determination that the respective content corresponding to the current cursor location is first content (e.g., for a first respective application), the computer system performs one or more functions for the first content. In some embodiments, the one or more functions include one or more of: moving the first content, changing an orientation and/or view of the first content, changing a size of the first content, changing one or more properties of the first content (e.g., color, opacity, size, or other property), scrolling the first content (e.g., to view additional items of the first content), adjusting one or more control options for the first content, and/or changing a volume associated with the first content). In some embodiments, performing one or more functions for the first content includes displaying one or more options (e.g., optionally as a carousel list that is displayed proximate to the current cursor location) for performing the one or more functions. For example, as described with reference to FIGS. 5F-5G, in response to detecting a rotation about the y-axis of input device 500 while the current location of cursor 506a corresponds to content 512 in application window 510a, an operation related to content 512 is performed (e.g., options for updating and/or interacting with content 512 are displayed as icons “1” “2” and “3”). In some embodiments, in accordance with a determination that that respective content corresponding to the current cursor location is second content that is different from the first content (e.g., second content for the first respective application or second content for a second respective application different from the first respective application), the computer system performs one or more functions for the second content. In some embodiments, the one or more functions include one or more of: moving the second content, changing an orientation and/or view of the second content, changing a size of the second content, changing one or more properties of the second content (e.g., color, opacity, size, or other property), scrolling the second content (e.g., to view additional items of the first content), adjusting one or more control options for the second content, and/or changing a volume associated with the second content). In some embodiments, performing one or more functions for the second content includes displaying one or more options (e.g., optionally as a carousel list that is displayed proximate to the current cursor location) for performing the one or more functions. For example, as described with reference to FIGS. 5F-5G, in response to detecting a rotation about the y-axis of input device 500 while the current location of cursor 506a corresponds to other content (e.g., other than content 512) in application window 510a and/or content in another application window, an operation related to the other content is performed. Performing a first function while the cursor is located over first content or performing a second function while cursor is located over second content, in response to a change in orientation of the input device, enables the user to perform content-specific operations with respect to particular content by moving the cursor over the desired content, without displaying additional controls, thereby reducing a number of inputs needed to perform the operation for the desired content.

In some embodiments, the first movement that includes a change in orientation of the input device comprises (620) a rotation of the input device about an axis that is substantially perpendicular to the physical surface (e.g., turning the input device clockwise and/or counterclockwise while the input device is in contact with the physical surface, optionally without lateral movement components such that the input device is rotated in place). For example, as described with reference to FIGS. 5F-5G, the input device changes in orientation by rotating (e.g., clockwise and/or counterclockwise) about the y-axis of input device 500 that is perpendicular to surface 504. Enabling a user to access additional controls for performing system operations by rotating the input device about an axis that is perpendicular to a surface, without requiring additional movement or navigation through complex menu hierarchies, reduces the number of inputs needed to perform the system operation.

In some embodiments, performing the system operation that is determined based at least in part on an amount of the change in orientation of the first movement includes (622) displaying one or more respective representations of respective applications (e.g., each representation corresponding to a respective application). In some embodiments, displaying the one or more respective representations of respective application includes displaying a multitasking view for application switching that displays a representations of applications that correspond to recently open applications. In some embodiments, the one or more respective representations of respective applications are displayed proximate to (e.g., at least partially surrounding) the current cursor location. For example, as illustrated in FIGS. 5F-5G, 5J-5L, and 5O-5P, icons are displayed as partially surrounding (e.g., optionally in a semicircle pattern) the current location of the cursor 506a. Displaying icons representing open and/or recently used applications near the current position of the cursor in response to detecting a rotation of the input device, reduces the number of inputs needed for the user to quickly switch between the open and/or recently used applications and provides the user with additional control options to multitask between applications.

In some embodiments, after detecting the first movement that includes a change in orientation of the input device, the computer system detects (624) additional movement (e.g., a continuation of the first movement) that includes a further change in orientation (e.g., in a same direction) of the input device. In some embodiments, in response to detecting the additional movement (e.g., in response to detecting the input device continues to rotate in a same direction, so as to scroll through the one or more representations), the computer system: ceases to display a first representation of the one or more representations; and displays one or more additional representations for one or more additional applications proximate to the current cursor location (e.g., as the input device rotates via the additional movement, the representations of the applications update to cycle through different applications). In some embodiments, a maximum number of representations (e.g., 3 representations, 4 representations, or another number) are concurrently displayed as a list (e.g., that curves around the current cursor location) and as the user scrolls through the representations via the additional input, a first representation disappears (e.g., from the beginning of the list of representations) and an additional representation appears (e.g., at the end of the list). For example, as described with reference to FIG. 5L, additional rotation of the input device 500 about the y-axis causes the computer system to cease display of icon A and display additional icon D (e.g., as well as continuing to display icons B and C at different positions surrounding the current location of the cursor 506a). Automatically ceasing display of icons that represent open and/or recently used applications, in response to the user scrolling through the icons, provides the user with access to additional controls, such as additional icons that replace display of the icons that have ceased to be displayed, without cluttering the user interface and provides visual feedback about a state of the computer system.

In some embodiments, in response to detecting the additional movement, the computer system generates (626) one or more haptic outputs (e.g., using a haptic output component in the input device) corresponding to the additional movement of the input device. (e.g., one or more haptic outputs are generated for each selection (e.g., via additional rotation of the input device) of a different representation). As the input device is rotated to scroll through the one or more representations of the respective applications, a haptic output is generated and output to indicate that a next representation has been selected by the additional movement. For example, as described with reference to FIG. 5L, input device 500 generates a haptic output to indicate when a next icon is currently selected in response to the user scrolling (e.g., via additional rotation of the input device 500) through the icons. Providing haptic outputs to indicate that the user is scrolling through additional icons and/or control options provides feedback about a state of the computer system.

In some embodiments, in response to detecting the first movement that includes a rotation of the input device about an axis that is substantially perpendicular to the physical surface, while displaying the one or more respective representations of respective applications (e.g., that are recently opened), the computer system displays (628) an indication of a currently selected representation of a respective application, including: in accordance with the first movement having a first amount of rotation, displaying the indication of the currently selected representation as a first representation of a first application (e.g., if the rotation is by a first amount (e.g., a first degree of rotation), a first application is selected); and in accordance with the first movement having a second amount of rotation that is greater than the first amount of rotation, displaying the indication of the currently selected representation as a second representation of a second application (e.g., if the rotation is by a second amount (e.g., a second degree of rotation optionally greater than the first degree of rotation), a second application is selected) (e.g., and optionally ceasing display of the first application icon). For example, as described with reference to FIGS. 5J-5M, application icons A, B, C, and D correspond to representations of open and/or recently used applications. For example, the icon for application A corresponds to application window 510a, the icon for application B corresponds to application window 510b, and the icon for application C corresponds to application window 510c. Cycling through icons that represent open and/or recently used applications in response to the user scrolling through the icons, provides the user with access to additional controls, such as additional icons that replace display of the icons that have ceased to be displayed, without cluttering the user interface and provides visual feedback about a state of the computer system.

In some embodiments, in accordance with a determination that a respective representation of a respective application is the currently selected representation, the computer system displays (630) an application window of the respective application in a foreground of the first user interface (e.g., displays one or more application windows in a first configuration (optionally including one or more application windows that partially overlap or otherwise occlude each other)); and in response to detecting the movement, the computer system updates the first configuration to a second configuration of the one or more application windows in which the application window of the respective application that is currently selected representation is moved to the foreground of the one or more application windows in the second configuration (e.g., such that the currently selected representation is in front of (e.g., not occluded by) other application windows displayed in the first user interface). For example, as described with reference to FIG. 5J, the application window corresponding to the currently selected icon is selected such that the application window is moved to the foreground of the user interface (e.g., in front of other open application windows that are displayed). Displaying an application window corresponding to a currently selected icon that represents an open and/or recently used application in front of other application windows and/or system user interfaces by changing the orientation of the input device, enables the user to quickly view and switch between application windows for other open applications without displaying additional controls.

In some embodiments, the first movement of the input device that includes a change in orientation of the input device comprises (632) a change in orientation, in a first direction, of the input device about an axis that is substantially parallel to the physical surface (e.g., optionally without being on the surface) (e.g., the input device is tilted or otherwise turned onto its side). For example, as described with reference to FIGS. 5R-5S, in response to detecting a change in orientation of input device 500 about the z-axis (e.g., that is parallel to surface 504), the computer system performs a multitasking operation that includes displaying open application windows 510a, 510b and 510c. Enabling a user to access additional controls for performing system operations by tilting the input device relative to a surface, without requiring additional movement or navigation through complex menu hierarchies, reduces the number of inputs needed to perform the system operation.

In some embodiments, prior to detecting the first movement of the input device, the computer system displays (634) one or more application windows for one or more applications in a first layout (e.g., front views of the one or more application windows) in the first user interface, wherein, in accordance with a determination that the first movement includes the change in orientation of the input device in the first direction about the axis that is substantially parallel to the physical surface, the computer system performing the system operation includes updating the first user interface to display the one or more application windows in a second layout that is different than the first layout (wherein the second layout comprises side views (e.g., viewing at an angle that is not directly in front) of the one or more application windows, the one or more application windows optionally stacked along a horizontal axis of the first user interface). For example, as described with reference to FIG. 5S, in response to detecting a change in orientation of input device 500 about the z-axis (e.g., that is parallel to surface 504), the computer system displays open application windows 510a, 510b and 510c with a side view to enable the user to select which application window to select to bring to the foreground of the user interface. Displaying a side view of open and/or recently used application windows in response to tilting the input device relative to a surface, without requiring additional movement or navigation through complex menu hierarchies, reduces the number of inputs needed to view and navigate between the open and/or recently used application windows, thereby improving access to the multitasking operation.

In some embodiments, while displaying, via the display generation component, a plurality of application windows in the first user interface: while the current cursor location is at a location corresponding to a first application window of the plurality of application windows, the computer system detects (636) movement of the input device that moves the current cursor location to a location corresponding to a second application window of the plurality of application windows. In some embodiments, in response to detecting the movement of the input device such that the current cursor location is at a location corresponding to a second application window of the plurality of application windows, the computer system updates focus corresponding to the cursor to (e.g., the current cursor location is moved to focus on) the second application window. In some embodiments, the currently focused application window is visually emphasized (e.g., larger, highlighted or otherwise emphasized as being selected). In some embodiments, the cursor is displayed at a location corresponding to the focus location. For example, as described with reference to FIG. 5T, moving the input device 500 from side to side causes the cursor 506b to move over a different application window 501c, causing application window 501c to become the in-focus application window, and displayed in the foreground of the user interface 501, as illustrated in FIG. 5U. Focusing on a different respective application window by moving the input device across the side view of open and/or recently used application windows, reduces the number of inputs needed change focus between the open and/or recently used application windows.

In some embodiments, after detecting the change in orientation, in the first direction, of the input device about the axis that is substantially parallel to the physical surface, the computer system detects (638) sixth movement of the input device that includes tilting the input device relative to the axis that is substantially parallel to the physical surface; and in response to detecting the sixth movement, the computer system updates focus of the cursor to (e.g., the current cursor location is moved for the cursor to focus on) a respective application window of the plurality of application windows based at least in part on an amount of tilting of the sixth movement. For example, as described with reference to FIGS. 5S-5T, tilting the input device by a different amount and/or in a different direction (e.g., tilting to the right as opposed to the tilt to the left shown in FIG. 5T) causes the cursor 506b to focus on another application window, such a application window 510b. Focusing on a different respective application window by moving the input device, in a different direction, across the side view of open and/or recently used application windows, reduces the number of inputs needed change focus between the open and/or recently used application windows.

In some embodiments, after detecting the change in orientation, in the first direction, of the input device about the axis that is substantially parallel to the physical surface, the computer system detects seventh movement that includes lateral movement of the input device (e.g., while the input device is turned sideways according to the change in orientation in the first direction about the axis that is substantially parallel to the physical surface); and in response to detecting the seventh movement, the computer system updates (640) focus of the cursor to (e.g., the current cursor location is moved to focus on) a respective application window of the plurality of application windows based at least in part on an amount of (e.g., and/or direction of) lateral movement of the seventh movement. For example, as described with reference to FIG. 5T lateral movement (e.g., to the left and/or right, relative to an axis that is parallel to the display 502), causes the cursor 506b to move to the left and/or right to focus on a particular application window, such as application window 510c. Focusing on a different respective application window by laterally moving the input device across the side view of open and/or recently used application windows, reduces the number of inputs needed change focus between the open and/or recently used application windows.

In some embodiments, while displaying, via the display generation component, the plurality of application windows in the first user interface: while the current cursor location is at a location corresponding to a first application window of the plurality of application windows, the computer system visually emphasizes (642) display of the first application window (e.g., displays the first application window in front of other application windows (e.g., in the foreground of the first user interface), displays the first application window as being in focus, optionally dims and/or otherwise visually deemphasizes application windows other than the first application window). In some embodiments, in response to detecting movement of the input device such that the current cursor location is at a location corresponding to a second application window of the plurality of application windows, the computer system visually emphasizes display of the second application window (e.g., displays the second application window in front of other application windows (e.g., in the foreground of the first user interface), displays the second application window as being in focus, optionally dims and/or otherwise visually deemphasizes application windows other than the second application window). In some embodiments, visually emphasizing display of the second application window includes highlighting, increasing a size of, increasing a luminance of, bringing forward in the display (e.g., in front of other application windows) and/or displaying an indication of focus for the second application window. In some embodiments, visually emphasizing display of the second application window includes dimming, decreasing a size of, decreasing a luminance of, pushing backwards in the display (e.g., relative to the second application window), and/or otherwise visually deemphasizing one or more application windows other than the second application window that are concurrently displayed with the second application window, optionally without changing visual properties of the second application window. For example, as described with reference to FIG. 5T, in some embodiments, the currently in-focus application window is visually emphasized, such as highlighted and/or increased in size, to indicate that the cursor 506b is focused on the current application window. Visually emphasizing the respective application window to indicate that the respective application window is the currently focused application window, and updating which respective application window is focused in response to movements of the input device, provides visual feedback about a state of the computer system.

In some embodiments, after detecting the change in orientation, in the first direction, of the input device about the axis that is substantially parallel to the physical surface, while the current cursor location is at a location corresponding to a respective application window of the plurality of application windows (e.g., while the input device is in a side orientation cause by the change in orientation in the first direction), the computer system detects (644) a change in orientation, in a second direction different from the first direction, of the input device about the axis that is substantially parallel to the physical surface (e.g., such that the input device is turned from its side orientation to its initial orientation). In some embodiments, the second direction is opposite the first direction. In some embodiments, in response to detecting the change in orientation, in the second direction, of the input device about the axis that is substantially parallel to the physical surface, the computer system displays the respective application window of the plurality of application windows in a foreground of the first user interface (e.g., as the selected application window such that the respective application window is not occluded by other application windows displayed in the first user interface). For example, as described with reference to FIG. 5U, in response to the input device 500 reversing its change in orientation, the application window 510c that was in-focus in FIG. 5T is selected to be displayed in the foreground of the user interface 501. Selecting a respective application window as the currently focused application window in response to detecting the input device changing in orientation (e.g., in a reverse direction) provides visual feedback about a state of the computer system.

In some embodiments, while displaying a first user interface element in the first user interface and while the current cursor location for the cursor corresponding to the input device is directed to the first user interface element, in response to detecting a change in orientation of the input device about an axis that is substantially perpendicular to the physical surface, the computer system performs (646) an operation related to the first user interface element (e.g., the change in orientation of the input device corresponds to a selection input of the first user interface element and as the change in orientation changes by varying amounts, a value for the first user interface element is updated in accordance with the amount of change in orientation). For example, as described with reference to FIGS. 5F-5G, while the cursor 506a is at a location that corresponds to content 512, in response to a rotation of the input device 100, a content-specific operation is performed, as indicated by icons “1” “2” and “3”. Performing an operation in response to detecting a rotation of the input device about an axis that is perpendicular to a surface while the cursor is located over a user interface element, enables the user to access control options for the user interface element without displaying additional controls, thereby reducing a number of inputs needed to perform the operation.

In some embodiments, performing the operation related to the first user interface element comprises (648) scrolling through the first user interface element (e.g., the first user interface element includes a list and/or content items and performing the operation comprises scrolling, viewing or otherwise cycling through the list and/or content items). In some embodiments, in response to detecting the change in orientation: in accordance with a determination that the change in orientation is by a first amount (e.g., and/or with a first speed), the computer system scrolls to a first option based on the first amount (e.g., and/or the first speed); and in accordance with a determination that the change in orientation is by a second amount (e.g., and/or with a second speed) different from the first amount (e.g., and/or first speed), the computer system scrolls to a second option (e.g., in a list of options) based on the second amount (e.g., and/or second speed). As such, the computer system scrolls through the list by a different amount (e.g., to a different option in the list of options) based on a magnitude (e.g., amount and/or speed) of change in orientation of the input device. For example, rotating the input device by a small amount scrolls to the first option in the list, and continuing to rotate the input device by a larger amount scrolls to another option farther down the list. In some embodiments, rotating the input device at a low speed scrolls to the first option in the list and rotating the input device at a higher speed scrolls to another option farther down the list. In some embodiments, a series of inputs causes the change in orientation of the input device to change over time, such that, as the user continues rotating or otherwise changing the orientation by a different magnitude, different options in the list are displayed and/or selected in accordance with the series of inputs. For example, as described with reference to FIG. 5G, in some embodiments, the content-specific operation related to content 512 comprises scrolling a list. Scrolling a list and/or through content displayed in the user interface element in response to detecting a rotation of the input device about an axis that is perpendicular to a surface while the cursor is located over a user interface element, enables the user to access control options, including scrolling through content, for the user interface element without displaying additional controls, thereby reducing a number of inputs needed to perform the operation.

In some embodiments, performing the operation related to the first user interface element comprises (650) adjusting a control (e.g., a slider control, a dial, or another control option). For example, in response to detecting the change in orientation: in accordance with a determination that the change in orientation is by a first amount and/or with a first speed, the computer system adjusts a setting controlled by the slider and/or dial control by an amount that is based on the first amount; and in accordance with a determination that the change in orientation is by a second amount and/or with a second speed, different from the first amount and/or first speed, the computer system adjusts the setting controlled by the slider and/or dial control by an amount that is based on the second amount and/or second speed. In some embodiments, a change in orientation of the input device in a first direction causes an increase in the setting controlled by the slider and/or dial control and a change in orientation of the input device in a second direction opposite the first direction causes a decrease in the setting controlled by the slider and/or dial control, or vice-versa. In some embodiments, a greater amount of change in orientation and/or a greater speed in changing the orientation causes the setting to be changed by a larger amount than a smaller amount of change in orientation of the input device. As such, the setting is adjusted in accordance with a magnitude (e.g., amount and/or speed) and/or direction of the change in orientation of the input device. For example, as described with reference to FIGS. 5AG-5AH, changing the orientation of input device 500 to rotate about the y-axis that is perpendicular to surface 504 causes the computer system to adjust the level of brightness of the display using the slider control for controlling the display brightness. Adjusting a slider and/or dial control element in response to detecting a rotation of the input device about an axis that is perpendicular to a surface while the cursor is located over the slider and/or dial control element, enables the user to access control options, including changing a value of the slider and/or dial, without displaying additional controls, thereby reducing a number of inputs needed to perform the operation.

In some embodiments, performing the operation related to the first user interface element comprises (652) adjusting a volume (e.g., a volume of the computer system, a volume of an application, and/or a volume of an external speaker). In some embodiments, the current cursor location is located over a volume control and in response to detecting the change in orientation, the volume is adjusted in accordance with an amount of change in orientation. For example, rotating the input device by a first respective amount in a first direction increases the volume level by an amount corresponding the first respective amount of rotation of the input device and rotating the input device by a second respective amount in the first direction increases the volume level by an amount corresponding to the second respective amount of rotation of the input device (e.g., where a greater amount of rotation of the input device causes a greater change in the volume level). In some embodiments, rotation of the input device in a second direction opposite the first direction decreases the volume level. For example, rotating the input device by a first respective amount in the second direction decreases the volume level by an amount corresponding the first respective amount of rotation of the input device and rotating the input device by a second respective amount in the second direction decreases the volume level by an amount corresponding to the second respective amount of rotation of the input device. For example, as described with reference to FIGS. 5AE-5AF, the volume of the computer system is adjusted using a sound control, optionally in response to changing the orientation of input device 500 as described with reference to FIGS. 5AG-5AH and/or changing the orientation of input device 500 as described with reference to FIGS. 5AE-5AF. Adjusting a volume in response to detecting a rotation of the input device about an axis that is perpendicular to a surface while the cursor is located over a user interface element that corresponds to volume control, reduces a number of inputs needed to adjust the volume.

In some embodiments, while detecting lateral movement of the input device: the computer system detects (654) a portion of the input device that is facing (e.g., closest to) the display generation component and setting, without additional user input, the detected portion as a front of the input device (e.g., wherein the front of the input device is used to detect movement of the input device, such as a change in orientation of the input device relative to the front of the input device (e.g., clockwise and/or counterclockwise)). For example, as described with reference to FIGS. 5A-5C, in some embodiments, input device 500 is symmetrical. Also, while the input device is shown as a wired mouse with a cord, in some embodiments, the input device 500 is wireless. In yet other embodiments, the front of the input device is dynamically determined. For example, the portion of the input device 500 that is closest, and/or pointing towards display 502 and/or another device, is dynamically assigned to be the front of the input device 500, such that the user can perform operations with the input device 500 without concern as to which side of the input device 500 is the front of the input device 500. In these embodiments, automatically detecting a portion of the input device that is facing a display or another device being controlled, and updating or assigning the detected portion to be the front of the input device, reduces a number of inputs needed to orient the input device and enables continuous feedback about a state of the input device without requiring the user to realign the input device.

In some embodiments, the input device comprises (656) a symmetrical shape (e.g., the input device comprises a rounded puck shape, a spheroid, an ellipsoid, or other symmetrical shape such that any side of the input device may be assigned as the front of the input device (e.g., that is facing the display generation component)). For example, as described with reference to FIGS. 5A-5C, in some embodiments, input device 500 is symmetrical in shape, such as a symmetrical spheroid. Providing an input device that is symmetrical in its shape enables the user to easily grip and manipulate the input device about six degrees of freedom without requiring the user to manually adjust or realign a particular portion of the input device to perform operations thereby reducing the burden on the user in providing inputs using the input device.

In some embodiments, the computer system detects (658), via the input device, a first portion of a user input for selecting a first object. In some embodiments, the user input for selecting the first object comprises changing an orientation of the input device. In some embodiments, the user input for selecting the first object comprises a click, tap, touch, swipe, or other input detected at or on a surface of the input device (or clicking one or more buttons built into the device). In some embodiments, in response to detecting the first portion of the user input for selecting the first object, in accordance with a determination that a second portion of the user input comprises movement of the input device, the computer system moves the first object in the first user interface in accordance with the second portion of the user input; and in response to detecting an end of the user input, the computer system displays the first object at its current location in the first user interface. For example, the input device is used to perform a drag and drop operation on the first object. In some embodiments, the first object is moved to a system user interface (e.g., a desktop or other system application user interface). In some embodiments, the first object is moved within an application window. In some embodiments, the first object is moved from one application window to another application window. For example, as described with reference to FIGS. 5X-5Z, three-dimensional object 516 is moved, via a drag and drop operation, from application window 510c to application window 510a and/or to system user interface 514. Performing a drag and drop operation for a user interface object using movements of the input device, including switching application windows by rotating the input device, to move the user interface object from one application window to another application window (e.g., and/or system user interface) without requiring the user input device to move laterally to switch to the other application window reduces the number of inputs needed to move an object between application windows.

In some embodiments, in accordance with a determination that the first movement includes a change in orientation of the input device (660) (e.g., a change in orientation relative to the physical surface or relative to an axis that is perpendicular to the physical surface such a tilt of a vertical axis of the device relative to an vector normal to the physical surface that the input device is in contact with or such as rotational movement about a vertical axis of the input device): in accordance with a determination that that change in orientation of the input device is in a first direction, the computer system performs the system operation (e.g., displays the multitasking view or performs another system operation) that is determined based at least in part on an amount of the change in orientation of the first movement; and in accordance with a determination that that change in orientation of the input device is in a second direction, the computer system forgoes performing the system operation. For example, as described with reference to FIGS. 5L-5M, in response to the input device 500 changing orientation in a first direction, such as clockwise, the multitasking operation is performed, and in response to the input device 500 changing orientation in the opposite direction, such as counterclockwise, the multitasking operation is not performed. Performing a system operation in response to detecting the input device changing orientation (e.g., rotating) in one direction, but not performing the system operation in response to detecting the input device changing orientation in a different direction enables the user to perform the system operation without displaying additional controls and provides the user with additional control options to perform a different operation by changing the orientation of the input device in the different direction.

In some embodiments, in accordance with a determination that the first movement includes a change in orientation of the input device (e.g., a change in orientation relative to the physical surface or relative to an axis that is perpendicular to the physical surface such a tilt of a vertical axis of the device relative to an vector normal to the physical surface that the input device is in contact with or such as rotational movement about a vertical axis of the input device) (662): in accordance with a determination that that change in orientation of the input device is in a clockwise direction, the computer system initiates performance of the system operation that is determined based at least in part on an amount of the change in orientation of the first movement; and in accordance with a determination that that change in orientation of the input device is in a counterclockwise direction, the computer system forgoes initiating performance of the system operation. For example, rotating the input device in one direction causes the system operation to be performed while rotating the input device in the other direction does not cause the system operation to be performed. In some embodiments, initiating performance of the system operation is performed in accordance with a determination that the change in orientation of the input device is in a counterclockwise direction; and forgoing initiating performance of the system operation is performed in accordance with a determination that the change in orientation of the input device is in a clockwise direction. For example, as described with reference to FIGS. 5J and 5M, in response to the input device 500 changing orientation in a first direction, such as clockwise, the multitasking operation is initiated in FIG. 5J, and in response to the input device 500 changing orientation in the opposite direction, such as counterclockwise, the multitasking operation is not initiated, as illustrated in FIG. 5M. Performing a system operation in response to detecting the input device rotating clockwise, but not performing the system operation in response to detecting the input device rotating counterclockwise enables the user to perform the system operation by rotating the input device clockwise, without displaying additional controls and provides the user with additional control options to perform a different operation by rotating the input device counterclockwise.

In some embodiments, in accordance with a determination that the first movement includes a change in orientation of the input device (664) (e.g., a change in orientation relative to the physical surface or relative to an axis that is perpendicular to the physical surface such a tilt of a vertical axis of the device relative to an vector normal to the physical surface that the input device is in contact with or such as rotational movement about a vertical axis of the input device): in accordance with a determination that that change in orientation of the input device is in a first respective direction, the computer system performs the system operation that is determined based at least in part on an amount of the change in orientation of the first movement; and in accordance with a determination that that change in orientation of the input device is in a second respective direction, the computer system performs a second system operation, different from the system operation, that is determined based at least in part on an amount (e.g., a magnitude and/or velocity) of the change in orientation of the first movement. For example, a clockwise rotation causes the device to perform a system operation that includes displaying a multitasking view (e.g., and/or changing a brightness, system volume and/or a different system operation) and a counterclockwise rotation causes the device to perform a different system operation, such as changing a brightness and/or a system volume (e.g., and/or displaying the multitasking view or a different system operation). In some embodiments, the user is enabled to control (e.g., set via a settings interface) how different changes in orientation of the input device are mapped to various system functions. For example, as described with reference to FIG. 5M, in some embodiments, in response to the input device 500 changing orientation in a second direction, such as counterclockwise, a different system operation (e.g., other than multitasking and/or other the system operation performed in response to the input device 500 changing orientation in a first direction opposite the second direction) is optionally performed. Performing a system operation in response to detecting the input device changing orientation (e.g., rotating) in one direction, and performing a different operation from the system operation in response to detecting the input device changing orientation in a different direction provides the user with additional control options to perform either the system operation or the different operation by changing the orientation of the input device a respective direction without displaying additional controls.

It should be understood that the particular order in which the operations in FIGS. 6A-6F have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 700) are also applicable in an analogous manner to method 600 described above with respect to FIGS. 6A-6F. For example, the input device, movements, and operations described above with reference to method 600 optionally have one or more of the characteristics of the input device, movements, and operations described herein with reference to other methods described herein (e.g., method 700). For brevity, these details are not repeated here.

FIGS. 7A-7D are flow diagrams illustrating method 700 of moving a cursor based on movements of an input device relative to a physical surface in accordance with some embodiments. Method 700 is performed at a computer system (e.g., device 300, FIG. 3A, or portable multifunction device 100, FIG. 1A) in communication with a display generation component and an input device. In some embodiments, the display generation component is a touch-screen display with a touch-sensitive surface is on or integrated with the display. In some embodiments, the display generation component is a display that is separate from the computer system. Some operations in method 700 are, optionally, combined and/or the order of some operations is, optionally, changed.

Method 700 provides a system controlled by an input device whereby lateral movement of the input device across a surface causes a cursor to move in accordance with the lateral movement and a liftoff the input device causes the cursor to move in accordance with the amount of space and/or distance between the input device and the surface. Thus, method 700 enables the user additional and more refined control over the cursor by moving the input device laterally and/or vertically, without cluttering the user interface by displaying additional controls and reduces the number of inputs needed to specify different operations that are performed based on whether the input device is touching the surface or lifted off the surface.

The computer system, while displaying, via the display generation component, a first user interface and while a current cursor location for a cursor corresponding to the input device is (e.g., wherein the cursor position corresponds to a position of the input device and is updated in position in response to detecting movement of the input device) at a first position in the first user interface, detects (702) movement of the input device. In some embodiments, the cursor is displayed at the current cursor location. In some embodiments, the cursor is not displayed at the current cursor location but when a cursor display event occurs (e.g., a click, press, move or tap input), the cursor is displayed at the current cursor location.

In response to detecting the movement of the input device (704): in accordance with a determination that the movement includes lateral movement of the input device relative to a physical surface that the input device is touching (e.g., resting on or moving on), the computer system displays (706) movement of the cursor to a second position in the first user interface (e.g., from the first position in the first user interface or from a position between the first position in the first user interface and the second position in the user first user interface) based on the lateral movement of the input device relative to the physical surface. For example, as described with reference to FIGS. 5D-5E, in response to detecting lateral movement of input device 500 while the input device 500 is on surface 504, the representation of cursor 506a is displayed as moving in the user interface 501 in accordance with the movement of the input device 500.

In response to detecting the movement of the input device (704): in accordance with a determination that the movement includes lifting the input device away from the physical surface (e.g., or otherwise detecting that the movement changes an angle of the input device relative to the surface), the computer system displays (708) movement of the cursor (in some embodiments, the cursor continues to be displayed and the appearance of the cursor is optionally updated (e.g., to change a size of the cursor, to display the cursor as a three-dimensional cursor and/or to include a shadow with the cursor)) to a third position in the first user interface based on a distance (e.g., vertical displacement of the input device that optionally further includes horizontal movements (e.g., that are parallel to the surface)) between the input device and the physical surface. In some embodiments, the third position is different from the second position. For example, as described with reference to FIGS. 5Q-5R, in response to detecting the input device 500 is lifted off the surface 504, the representation of cursor 506b is displayed as moving in the user interface 501 in accordance with the movement of the input device 500.

In some embodiments, in accordance with a determination that the movement includes lifting the input device away from the physical surface, the computer system displays (710) movement of the cursor to the third position in the first user interface includes displaying movement of the cursor based on movement detected about six degrees of freedom of the input device For example, the computer system detects movement in all directions of the input device. For example, as described with reference to FIGS. 5Q and 5S, while the input device 500 is lifted off the surface 504, the cursor 506b is updated in accordance with movements of the input device 500 about six degrees of freedom, including tilts, rotations, lateral movements, vertical movements and other movements of the input device 500. Recognizing movements of the input device across six degrees of freedom while the input device is lifted off of the surface, and performing different operations, including moving the cursor in different directions, in response to movements of the input device across the six degrees of freedom provides additional control options with the input device without displaying additional controls and makes controlling the computer system more efficient (e.g., by providing additional options to explore and navigate content).

In some embodiments, in accordance with a determination that the movement includes lateral movement of the input device relative to the physical surface that the input device is touching, the computer system displays (712) the cursor corresponding to the input device with a first set of visual properties (e.g., the cursor is displayed as a two-dimensional object in the user interface); and in accordance with a determination that the movement includes lifting the input device away from the physical surface, the computer system displays the cursor corresponding to the input device with a second set of visual properties (e.g., the cursor is displayed as a three-dimensional object in the user interface) that is different from the first set of visual properties. In some embodiments, while moving the input device while the input device is touching, the cursor is displayed with the first set of visual properties and in response to detecting that the input device is moved (e.g., lifted) away from the physical surface, display of the cursor is updated to display the cursor with the second set of visual properties. For example, as described with reference to FIG. 5Q, the representation of cursor 506b that is optionally displayed while the input device 500 is lifted off the surface 504 is visually different from the representation of cursor 506a that is optionally displayed while the input device 500 is on the surface 504. For example, the representation of cursor 506b is a three-dimensional representation of the cursor while the representation of cursor 506a is a two-dimensional representation of the cursor. Changing the visual appearance of the cursor while the input device is lifted off the surface as compared to the visual appearance of the cursor while the input device is on the surface provides improved visual feedback about the state of the input device. These and other benefits of method 700 are particularly beneficial to users with reduced vision (or other visual impairments), making user interaction with in a mixed-reality three-dimensional environment more accessible to a wider population.

In some embodiments, displaying the cursor with the second set of visual properties includes (714) displaying the cursor as having a nonzero distance (e.g., along the z-axis) between the cursor and the first user interface. For example, as described with reference to FIG. 5Q, representation of the cursor 506b is displayed as being in front of and/or lifted off of the application window 510b. Displaying the cursor as lifting away from the displayed user interface, while the input device is lifted off the surface, to create the visual effect of distance between the user interface and the cursor provides visual feedback about the state of the input device.

In some embodiments, displaying the cursor with the second set of visual properties includes (716) concurrently displaying the cursor and a shadow of the cursor. For example, the shadow of the cursor is optionally displayed below the cursor and follows movements of the cursor. For example, as described with reference to FIG. 5Q, in some embodiments, the representation of cursor 506b that is displayed optionally while the input device 500 is lifted off of the surface 504 includes a shadow that follows the representation of cursor 506b, thereby displaying the cursor 506b as a three-dimensional cursor that creates a shadow below it. Displaying the cursor with a shadow in the displayed user interface, while the input device is lifted off the surface, to create the visual effect the cursor being displayed as a three-dimensional cursor provides visual feedback about the state of the input device.

In some embodiments, displaying the cursor with the second set of visual properties includes (718) displaying the cursor as changing orientation (e.g., tilting) in accordance with a detected change in orientation (e.g., tilting around the z-axis) of the input device. For example, as described with reference to FIGS. 5Q and 5V, in some embodiments, the representation of the cursor 506b is displayed as tilting in accordance with the tilting movements of the input device 500. Displaying the cursor as tilting within the displayed user interface in response to the input device tilting, while the input device is lifted off the surface, to create the visual effect of the cursor moving along with the tilt and/or movement of the input device and the cursor provides visual feedback about the state of the input device and provides the user with additional and more refined control over the cursor, using the input device, without displaying additional controls.

In some embodiments, displaying the cursor as changing orientation includes (720) displaying the cursor as tilting into (e.g., as if tilting a top of the icon to face away from the viewpoint of the user and into the display generation component) (e.g., tilting about an x-axis that runs parallel to the display generation component and/or first user interface) the first user interface in accordance with movement of the input device closer to the display generation component In some embodiments, in response to detecting movement of the input device as moving farther away from the display generation component and/or in response to detecting movement of the input device that tilts the input device (e.g., upward and/or downward) about an x-axis that runs parallel to the display generation component, displaying the cursor as tilting about the x-axis in the first user interface in accordance with the movement of the input device. For example, as described with reference to FIG. 5R, the representation of the cursor 506b is displayed as tilting into the user interface 501 (e.g., appearing farther away than application window 510b) in response to movement of the input device 500 moving closer to the display 502. Displaying the cursor moving deeper into the displayed user interface, such as tilting forward into the display, while the input device is lifted off the surface in response to a tilting forward of the input device, provides visual feedback about the state of the input device and provides the user with additional and more refined control over movement of the cursor, using the input device, without displaying additional controls.

In some embodiments, displaying the cursor as changing orientation includes (722) displaying the cursor as tilting left or right (e.g., tilting about the z-axis that runs perpendicular to the display generation component and/or first user interface) in accordance with a detected change in orientation relative to an axis that is substantially parallel to the physical surface of the input device. For example, the cursor is displayed as tilting to the left and right in the first user interface in accordance with tilting of the input device. For example, as described with reference to FIGS. 5Y-5Z, tilting the input device 500 to the left and/or right about the z-axis causes the representation of cursor 506b to be displayed as tilting to the left and/or right based on a magnitude (e.g., speed, direction and/or amount) of movement of the input device 500. Displaying the cursor tilting left and/or right within the displayed user interface, while the input device is lifted off the surface in response to a side-to-side tilting of the input device provides visual feedback about the state of the input device and provides the user with additional and more refined control over movement of the cursor, using the input device, without displaying additional controls.

In some embodiments, detecting (724) via the input device, a selection user input, and in response to detecting the selection user input, displaying the cursor as moving along a z-axis (e.g., changes in perceived depth) relative to the first user interface. For example, as described with reference to FIGS. 5R and 5T, in some embodiments, the representation of the cursor 506b moves along the z-axis, as if appearing to go farther away within the user interface 501 in response to selection of application window 510c (e.g., optionally in response to a selection input, such as a touch and/or tap input on the input device 500). Displaying the cursor moving deeper into the displayed user interface, while the input device is lifted off the surface, to create the visual effect of the cursor being able to travel in three-dimensions, including adjusting a depth of the cursor relative to other displayed objects in the user interface, provides visual feedback about the state of the input device and provides the user with additional and more refined control over the cursor, using the input device, without displaying additional controls.

In some embodiments, in response to detecting, via the input device, a touch user input (e.g., a tap, a swipe, and/or another gesture performed on a surface of the input device), the computer system performs (726) a selection operation. For example, content (e.g., an application window, a user interface object, or other content item) that is displayed at a location corresponding to the current cursor location is selected by the selection operation. For example, as described with reference to FIGS. 5R and 5T, in some embodiments, selecting a user interface object, such as application window 510c, is performed in response to a tap and/or touch input of the input device 500 (e.g., a user tapping the user's finger or portion of the user's hand or otherwise performing a touch gesture on the input device 500). Detecting user inputs, such as selection inputs, via the user touching and/or tapping on the input device, both while the input device is on the surface and lifted off the surface, and, in response to the selection inputs, selecting content, enables the user to make selections without displaying additional controls.

In some embodiments, performing the selection operation includes (728) updating display of the cursor as moving toward content that is selected via the selection operation. For example, the cursor is displayed as moving inward in the first user interface as if moving, along the z-axis, toward the content that is displayed at the location corresponding to the current cursor location when selected by the selection operation. For example, as described with reference to FIG. 5R, in some embodiments, the representation of the cursor 506b is displayed as moving towards the selected application window 510a. Displaying the cursor moving toward the content that is selected in response to detecting a selection input, even while the input device is lifted off the surface, provides visual feedback about the selected content.

In some embodiments, in accordance with a determination that the movement includes lateral movement of the input device relative to the physical surface that the input device is touching, the computer system navigates (730) the first user interface using a first type of cursor. For example, while the input device is on the physical surface and/or moving laterally along a plane that is substantially parallel to the physical surface (e.g., without movement along the y-axis), the computer system is navigated using the input device as a mouse (e.g., according to lateral movement) and optionally displays the cursor as a first type of cursor. In accordance with a determination that the movement includes lifting the input device away from the physical surface, the computer system navigates the first user interface using a second type of cursor that is different from the first type of cursor. For example, while the input device is detected as being away from the physical surface, the computer system is navigated using the input device as a pointer (e.g., according to six degrees of freedom) and optionally displays the cursor as a second type of cursor (and/or does not display the cursor). For example, as described with reference to FIG. 5AK, in some embodiments, a navigation model used to navigate the user interface 501 is changed in response to detecting the input device 500 is lifted off the surface 504. Automatically switching a display mode in which navigation is performed using a cursor with a first set of properties (e.g., the cursor, when displayed, is displayed in a first manner) while the input device is on the surface, to a display mode in which navigation is performed using a cursor with a second set of properties (e.g., the cursor is optionally not displayed and/or is displayed in a second manner) enables the user to navigate the user interface more naturally based on the current state of the input device without requiring additional user input for the user to manually adjust the display mode settings, and provides visual feedback about the state of the input device.

In some embodiments, navigating using the first type of cursor comprises (732) displaying the cursor as a visual icon that moves in accordance with movement of the input device. In some embodiments, navigating the first user interface using the first type of cursor includes displaying a cursor as an icon (e.g., as a mouse icon or other visual icon) to indicate the current cursor location. In some embodiments, navigating using the second type of cursor comprises displaying content at a location that corresponds to the current cursor location as having visual emphasis relative to content displayed at locations that do not correspond to the current cursor location (e.g., optionally without displaying the visual icon that represents the cursor). In some embodiments, navigating the first user interface using the second type of cursor includes forgoing displaying a cursor as an icon (e.g., as a mouse icon or other visual icon) to indicate the current cursor location. In some embodiments, the second type of cursor is not displayed and the current cursor location is indicated by visually emphasizing the content that is displayed at the location corresponding to the current cursor location. For example, as described with reference to FIG. 5AK, while the input device 500 is touching the surface 504, the navigation model uses a cursor that is optionally displayed in response to detecting lateral movements of the input device 500, and while the input device 500 is not touching the surface 504, the navigation model optionally does not display a representation of a cursor and instead updates the user interface 501 to indicate a current location of the cursor. Automatically switching between navigating the user interface using a cursor with a first set of properties (e.g., the cursor, when displayed, is displayed in a first manner) while the input device is on the surface, to a navigating the user interface using a cursor with a second set of properties (e.g., the cursor is optionally not displayed and/or is displayed in a second manner) enables the user to navigate the user interface more naturally based on the current state of the input device without requiring additional user input for the user to manually adjust the display mode settings, and provides visual feedback about the state of the input device.

In some embodiments, navigating using the first type of cursor comprises (734) displaying the first user interface in a first manner. For example, the first user interface displayed in the first manner comprises a desktop and/or one or more application windows. In some embodiments, navigating using the second type of cursor comprises displaying the first user interface in a second manner that is different from the first manner. For example, the first user interface displayed in the second manner comprises a media browsing user interface that displays (e.g., optionally in a media application window) media content. For example, as described with reference to FIG. 5AK, in some embodiments, in response to detecting the input device 500 lifted off surface 504, the user interface 501 is updated to a media-navigation mode of display such that content and/or application windows are selectable without displaying a representation of the cursor. Displaying the user interface as a first type of user interface while the input device is on the surface to be navigated using the cursor with the first set of properties and displaying the user interface as a second type of user interface, such as a browsing user interface, while the input device is not on the surface, to be navigated using the cursor with the second set of properties makes it easier for the user to view and/or select content in the user interface that is updated based on the state of the input device, without requiring additional user input for the user to manually adjust the type of user interface to be displayed, and provides visual feedback about the state of the input device.

In some embodiments, while displaying a three-dimensional object in the first user interface, in response to detecting second movement of the input device (e.g., optionally while the current cursor location corresponds to the displayed location of the three-dimensional object), in accordance with a determination that the second movement includes lifting the input device away from the physical surface, the computer system changes (736) an orientation of the three-dimensional object in accordance with movement detected about six degrees of freedom of the input device. For example, as described with reference to FIG. 5Q, the computer system detects movement of the input device 500 about six degrees of freedom, including rotation of the input device 500 about the y-axis (e.g., clockwise and/or counterclockwise rotation), tilt (e.g., and/or rotation) of the input device about the z-axis (e.g., tilting side-to-side relative to the display 502), and tilt (e.g., and/or rotation) of the input device about the x-axis (e.g., tilting forward-to-back relative to the display 502). Recognizing movements of the input device across six degrees of freedom while the input device is lifted off of the surface, and causing a selected object, displayed in the user interface, to move across six degrees of freedom, in response to movements of the input device across the six degrees of freedom provides additional control options for controlling the selected object with the input device without displaying additional controls.

In some embodiments, while displaying the three-dimensional object in the first user interface, in response to detecting the second movement of the input device (e.g., optionally while the current cursor location corresponds to the displayed location of the three-dimensional object), in accordance with a determination that the second movement includes lateral movement of the input device relative to the physical surface that the input device is touching, the computer system performs (738) one or more operations in response to a user input (e.g., a tap and/or touch input, a swipe input, a click-down and/or a select-and-drag (e.g., click and hold)) directed to the input device. For example, as described with reference to FIG. 5AA, while the input device 500 is on the surface 504, the three-dimensional object 516 is controlled via lateral movements and/or selection inputs, such as clicks and/or drags, of the input device 500. Controlling a selected object that is displayed in the user interface using selection inputs, such as clicks, taps, and/or touches, via the input device and/or using lateral movements of the input device, while the input device is on the surface, provides additional control options for controlling the selected object with the input device without displaying additional controls.

In some embodiments, changing the orientation of the three-dimensional object in accordance with movement detected about six degrees of freedom of the input device includes (740) changing the orientation of the three-dimensional object by a first factor in accordance with movement of the input device by a second factor different from the first factor. For example, a degree of rotation of the three-dimensional object is scaled (e.g., to rotate 1.5×, 2×, 5×, or another factor) relative to the degree of rotation (e.g., movement) detected by the input device. For example, as described with reference to FIG. 5V, rotation of the input device 500 causes three-dimensional object 516 to rotate at a scaled rate in accordance with the rotation of input device 500. Rotating a three-dimensional object that is displayed within the user interface in response to inputs that are detected across six degrees of freedom while the input device is lifted off of the surface and that are detected via lateral movement while the input device is on the surface, where the rotation is performed at a rate with a different factor than the detected rate of movement of the input device, reduces the number of inputs, including movements by the input device, needed for the user to rotate the three-dimensional object by a greater and/or lesser amount.

In some embodiments, in response to detecting lateral movement of the input device, the computer system displays (742) the three-dimensional object as moving laterally in the first user interface in accordance with the lateral movement of the input device; and in response to detecting vertical movement of the input device, the computer system displays the three-dimensional object as moving vertically in the first user interface in accordance with the vertical movement of the input device. For example, the three-dimensional object is mapped to the input device such that movement of the input device up, down, right and/or left causes the three-dimensional object to be displayed as moving up, down, right and/or left in accordance with the detected movement of the input device. For example, as described with reference to FIGS. 5Y-5Z, the three-dimensional object 516 is moved laterally (e.g., up, down, left and/or right) in accordance with lateral movement (e.g., along the x-axis) of the input device 500. Recognizing movements of the input device up, down, left and/or right, both while the input device is on the surface and is lifted off the surface, and moving a selected object that is displayed in the user interface in different directions, in response to, and in accordance with, the movements of the input device up, down, left and/or right provides additional control options for controlling the selected object with the input device without displaying additional controls.

In some embodiments, while the input device is away from the physical surface (e.g., after detecting the second movement that includes lifting the input device away from the physical surface), the computer system detects (744), via the input device, an input directed to (e.g., where a front portion of the input device is pointed to) an electronic device that is different from the computer system. In some embodiments, the electronic device is a speaker system, a tablet, a smartphone, a laptop, a television, or another type of electronic device. In some embodiments, the electronic device is optionally coupled to the computer system (e.g., via Bluetooth, wirelessly, a shared user account, and/or a wired connection). In some embodiments, in response to detecting the input directed to the electronic device, the computer system performs one or more operations at the electronic device (e.g., controls a volume of the electronic device, controls a brightness and/or other system function of the electronic device, performs one or more selection inputs (e.g., as a remote control), and/or otherwise navigates a user interface of the electronic device). For example, as described with reference to FIGS. 5AJ-5AL, the input device 500 optionally controls device 2 in response to detecting that the input device 500 is pointing to, or otherwise selecting, device 2. Controlling one or more other devices, separate from the computer system, using the same input device while the input device is lifted off the surface, provides the user with additional control options for interacting with the one or more other devices without displaying additional controls and without the need for an additional input device to interact across multiple devices and/or computer systems.

In some embodiments, in response to detecting the input directed to the electronic device, the computer system updates (746) a user interface of the electronic device to indicate that the input device is directed to the electronic device. For example, the electronic device displays an indication that the input device is detected and that the input device is being used to control the electronic device. For example, as described with reference to FIG. 5AJ, in some embodiments, device 2 includes a display that displays a user interface that is updated to indicate that device 2 is being controlled by input device 500. Automatically updating a user interface that is displayed by a device, separate from the computer system, in response to detecting that the input device is directed to the device, provides the user with additional control options for interacting with the device without requiring the user to manually configure the device to switch between controlling the device and the computer system and without the need for an additional input device to interact across multiple devices and/or computer systems.

In some embodiments, in response to detecting the input directed to the electronic device, the computer system (and/or the electronic device) displays (748) an indication (e.g., updates the display of the electronic device, outputs audio and/or a haptic, illuminates one or more lights of the electronic device, or outputs another indication from the electronic device and/or the input device) that the input device is directed to the electronic device. For example, as described with reference to FIG. 5AJ, in some embodiments, device 2 displays and/or outputs a visual and/or audio indication indicating the input device 500 is detected by device 2. Automatically displaying an indication that a device, separate from the computer system, has detected that the input device is directed to the device, provides the user with visual feedback about the state of the input device and provides additional control options for interacting with the device without the need for an additional input device to interact across multiple devices and/or computer systems.

In some embodiments, in response to detecting the input directed to the electronic device, wherein the input is detected while the electronic device displays a second user interface, the computer system (and/or the electronic device) updates (750) display of the second user interface to a third user interface (e.g., the third user interface corresponding to a user interface for responding to a remote control), wherein content displayed in the third user interface is selectable using the input device. For example, as described with reference to FIG. 5AJ, the user interface displayed by device 2 is adapted for being controlled by a remote control, such that input device 500 functions as a remote control to cause device 2 to perform one or more operations. Automatically updating a user interface, displayed at a device different from the computer system, to be displayed with a layout designed to be controlled by a remote input device, such as a remote control, in response to detecting that the input device is directed to the device, makes it easier for the user to navigate and/or select content in the user interface while it is displayed with the layout designed to be controlled by a remote input device, thereby reducing a number of inputs needed for the user to navigate and control the device using the input device.

In some embodiments, while displaying a first user interface element and while the current cursor location for the cursor corresponding to the input device is directed to the first user interface element, in response to detecting a change in orientation of the input device about an axis that is substantially perpendicular to the physical surface, the computer system performs (752) an operation related to the first user interface element (e.g., the change in orientation of the input device corresponds to a selection input of the first user interface element and as the change in orientation changes by varying amounts, a value for the first user interface element is updated in accordance with a magnitude (e.g., amount and/or speed) and/or direction of change in orientation). For example, as described with reference to FIG. 5AJ, in some embodiments, rotation of the input device 500 causes one or more operations to be performed by device 2 while the input device 500 is directed to device 2. Performing an operation in response to detecting a rotation of the input device about an axis that is perpendicular to a surface while the cursor is located over a user interface element, enables the user to access control options for the user interface element without displaying additional controls, thereby reducing a number of inputs needed to perform the operation.

In some embodiments, performing the operation related to the first user interface element comprises (754) scrolling through the first user interface element (e.g., the first user interface element includes a list and/or content items and performing the operation comprises scrolling, viewing or otherwise cycling through the list and/or content items). In some embodiments, in response to detecting the change in orientation: in accordance with a determination that the change in orientation is by a first amount (e.g., and/or with a first speed), the computer system scrolls to a first option based on the first amount (e.g., and/or the first speed); and in accordance with a determination that the change in orientation is by a second amount (e.g., and/or with a second speed) different from the first amount (e.g., and/or first speed), the computer system scrolls to a second option (e.g., in a list of options) based on the second amount (e.g., and/or second speed). As such, the computer system scrolls through the list by a different amount (e.g., to a different option in the list of options) based on a magnitude (e.g., amount and/or speed) of change in orientation of the input device. For example, rotating the input device by a small amount scrolls to the first option in the list, and continuing to rotate the input device by a larger amount scrolls to another option farther down the list. In some embodiments, rotating the input device at a low speed scrolls to the first option in the list and rotating the input device at a higher speed scrolls to another option farther down the list. In some embodiments, a series of inputs causes the change in orientation of the input device to change over time, such that, as the user continues rotating or otherwise changing the orientation by a different magnitude, different options in the list are displayed and/or selected in accordance with the series of inputs. For example, as described with reference to FIG. 5G, in some embodiments, the content-specific operation related to content 512 comprises scrolling a list. Scrolling through a list and/or through content displayed in the user interface element in response to detecting a rotation of the input device about an axis that is perpendicular to a surface while the cursor is located over a user interface element, enables the user to access control options, including scrolling through content, for the user interface element without displaying additional controls, thereby reducing a number of inputs needed to perform the operation.

In some embodiments, performing the operation related to the first user interface element comprises (756) adjusting a control (e.g., a slider control, a dial, or another control option). For example, in response to detecting the change in orientation: in accordance with a determination that the change in orientation is by a first amount and/or with a first speed, the computer system adjusts a setting controlled by the slider and/or dial control by an amount that is based on the first amount; and in accordance with a determination that the change in orientation is by a second amount and/or with a second speed, different from the first amount and/or first speed, the computer system adjusts the setting controlled by the slider and/or dial control by an amount that is based on the second amount and/or second speed. In some embodiments, a change in orientation of the input device in a first direction causes an increase in the setting controlled by the slider and/or dial control and a change in orientation of the input device in a second direction opposite the first direction causes a decrease in the setting controlled by the slider and/or dial control, or vice-versa. In some embodiments, a greater amount of change in orientation and/or a greater speed in changing the orientation causes the setting to be changed by a larger amount than a smaller amount of change in orientation of the input device. As such, the setting is adjusted in accordance with a magnitude (e.g., amount and/or speed) and/or direction of the change in orientation of the input device. For example, as described with reference to FIGS. 5AG-5AH, changing the orientation of input device 500 to rotate about the y-axis that is perpendicular to surface 504 causes the computer system to adjust the level of brightness of the display using the slider control for controlling the display brightness. Adjusting a slider and/or dial control element in response to detecting a rotation of the input device about an axis that is perpendicular to a surface while the cursor is located over the slider and/or dial control element, enables the user to access control options, including changing a value of the slider and/or dial, without displaying additional controls, thereby reducing a number of inputs needed to perform the operation.

In some embodiments, performing the operation related to the first user interface element comprises (758) adjusting a volume (e.g., a volume of the computer system, a volume of an application, and/or a volume of an external speaker). In some embodiments, the current cursor location is located over a volume control and in response to detecting the change in orientation, the volume is adjusted in accordance with an amount of change in orientation. For example, rotating the input device by a first respective amount in a first direction increases the volume level by an amount corresponding the first respective amount of rotation of the input device and rotating the input device by a second respective amount in the first direction increases the volume level by an amount corresponding to the second respective amount of rotation of the input device (e.g., where a greater amount of rotation of the input device causes a greater change in the volume level). In some embodiments, rotation of the input device in a second direction opposite the first direction decreases the volume level. For example, rotating the input device by a first respective amount in the second direction decreases the volume level by an amount corresponding the first respective amount of rotation of the input device and rotating the input device by a second respective amount in the second direction decreases the volume level by an amount corresponding to the second respective amount of rotation of the input device. For example, as described with reference to FIGS. 5AE-5AF, the volume of the computer system is adjusted using a sound control, optionally in response to changing the orientation of input device 500 as described with reference to FIGS. 5AG-5AH and/or changing the orientation of input device 500 as described with reference to FIGS. 5AE-5AF. Adjusting a volume in response to detecting a rotation of the input device about an axis that is perpendicular to a surface while the cursor is located over a user interface element that corresponds to volume control, reduces a number of inputs needed to adjust the volume without requiring the user to perform additional selection and/or dragging movements.

It should be understood that the particular order in which the operations in FIGS. 7A-7D have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 600) are also applicable in an analogous manner to method 700 described above with respect to FIGS. 7A-7D. For example, the input device, movements, and operations described above with reference to method 700 optionally have one or more of the characteristics of the input device, movements, and operations described herein with reference to other methods described herein (e.g., method 600). For brevity, these details are not repeated here.

The operations described above with reference to FIGS. 6A-6G and 7A-7D are, optionally, implemented by components depicted in FIGS. 1A-1B. For example, updating operation 606, system operation 608, displaying operation 706, displaying operation 709, operation 752 are, optionally, implemented by event sorter 170, event recognizer 180, and event handler 190. Event monitor 171 in event sorter 170 detects an input via input device 500, and event dispatcher module 174 delivers the event information to application 136-1. A respective event recognizer 180 of application 136-1 compares the event information to respective event definitions 186, and determines whether the detected input corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the inventions to the precise forms disclosed. Many modifications and variations are possible in view of the above teachings. The embodiments were chosen and described in order to best explain the principles of the inventions and their practical applications, to thereby enable others skilled in the art to best use the inventions and various described embodiments with various modifications as are suited to the particular use contemplated.

What is claimed is:

1. A method, comprising:
at a computer system that is in communication with a display generation component and an input device:
while displaying, via the display generation component, a first user interface, while a current cursor location for a cursor corresponding to the input device is at a first location of the first user interface:
in response to detecting first movement of the input device:
in accordance with a determination that the first movement includes lateral movement of the input device relative to a physical surface that the input device is touching, updating display of the cursor as moving based on the lateral movement of the input device on the physical surface; and
in accordance with a determination that the first movement includes a change in orientation of the input device, performing a system operation that is determined based at least in part on an amount of the change in orientation of the first movement.

2. The method of claim 1, wherein performing the system operation that is determined based at least in part on an amount of the change in orientation of the first movement comprises displaying an application switching view that displays a plurality of representations of applications that correspond to recently open applications.

3. The method of claim 1, further including, while the current cursor location is at a second location of the first user interface, in response to detecting second movement of the input device:
in accordance with a determination that the second movement includes lateral movement of the input device relative to the physical surface that the input device is touching, updating display of the cursor as moving based on the lateral movement of the input device on the physical surface; and
in accordance with a determination that the second movement includes a change in orientation of the input device, performing an operation associated with content that is displayed at the second location of the first user interface.

4. The method of claim 1, wherein:
the first location of the first user interface corresponds to a system user interface of the computer system displayed in the first user interface;
performing the system operation that is determined based at least in part on an amount of the change in orientation of the first movement comprises displaying an application switching view that displays a plurality of representations of applications that correspond to recently open applications; and
the method further includes:
while the current cursor location is at a location corresponding to an application user interface displayed in the first user interface, in response to detecting third movement of the input device:
in accordance with a determination that the third movement includes a change in orientation of the input device, performing an operation for an application corresponding to the application user interface displayed in the first user interface at the current cursor location.

5. The method of claim 1, further including, while the current cursor location is at a location corresponding to a respective application user interface displayed in the first user interface, in response to detecting fourth movement of the input device, in accordance with a determination that the fourth movement includes a change in orientation of the input device:
in accordance with a determination that a respective application corresponding to the current cursor location is a first application user interface associated with a first application, performing a first operation for the first application; and
in accordance with a determination that the respective application corresponding to the current cursor location is a second application user interface associated with a second application, performing a second operation, different from the first operation, for the second application.

6. The method of claim 1, further including:
while the current cursor location is at a location corresponding to respective content of a respective application displayed in the first user interface, in response to detecting fifth movement of the input device, in accordance with a determination that the fifth movement includes a change in orientation of the input device:
in accordance with a determination that the respective content corresponding to the current cursor location is first content, performing one or more functions for the first content; and
in accordance with a determination that that respective content corresponding to the current cursor location is second content that is different from the first content, performing one or more functions for the second content.

7. The method of claim 1, wherein the first movement that includes a change in orientation of the input device comprises a rotation of the input device about an axis that is substantially perpendicular to the physical surface.

8. The method of claim 7, wherein performing the system operation that is determined based at least in part on an amount of the change in orientation of the first movement includes displaying one or more respective representations of respective applications, wherein the one or more respective representations of respective applications are displayed proximate to the current cursor location.

9. The method of claim 8, further including, after detecting the first movement that includes a change in orientation of the input device, detecting additional movement that includes a further change in orientation of the input device; and
in response to detecting the additional movement:
ceasing to display a first representation of the one or more representations; and
displaying one or more additional representations for one or more additional applications proximate to the current cursor location.

10. The method of claim 9, further including, in response to detecting the additional movement, generating one or more haptic outputs corresponding to the additional movement of the input device.

11. The method of claim 8, further including, in response to detecting the first movement that includes a rotation of the input device about an axis that is substantially perpendicular to the physical surface, while displaying the one or more respective representations of respective applications, displaying an indication of a currently selected representation of a respective application, including:
in accordance with the first movement having a first amount of rotation, displaying the indication of the currently selected representation as a first representation of a first application; and
in accordance with the first movement having a second amount of rotation that is greater than the first amount of rotation, displaying the indication of the currently selected representation as a second representation of a second application.

12. The method of claim 11, including, in accordance with a determination that a respective representation of a respective application is the currently selected representation, displaying an application window of the respective application in a foreground of the first user interface.

13. The method of claim 1, wherein the first movement of the input device that includes a change in orientation of the input device comprises a change in orientation, in a first direction, of the input device about an axis that is substantially parallel to the physical surface.

14. The method of claim 13, further including, prior to detecting the first movement of the input device, displaying one or more application windows for one or more applications in a first layout in the first user interface,
wherein, in accordance with a determination that the first movement includes the change in orientation of the input device in the first direction about the axis that is substantially parallel to the physical surface, performing the system operation includes updating the first user interface to display the one or more application windows in a second layout that is different than the first layout.

15. The method of claim 13, further including, while displaying, via the display generation component, a plurality of application windows in the first user interface:
while the current cursor location is at a location corresponding to a first application window of the plurality of application windows, detecting movement of the input device that moves the current cursor location to a location corresponding to a second application window of the plurality of application windows; and
in response to detecting the movement of the input device such that the current cursor location is at a location corresponding to a second application window of the plurality of application windows, updating focus corresponding to the cursor to the second application window.

16. The method of claim 15, including:
after detecting the change in orientation, in the first direction, of the input device about the axis that is substantially parallel to the physical surface, detecting sixth movement of the input device that includes tilting the input device relative to the axis that is substantially parallel to the physical surface; and
in response to detecting the sixth movement, updating focus of the cursor to a respective application window of the plurality of application windows based at least in part on an amount of tilting of the sixth movement.

17. The method of claim 15, including:
after detecting the change in orientation, in the first direction, of the input device about the axis that is substantially parallel to the physical surface, detecting seventh movement that includes lateral movement of the input device; and
in response to detecting the seventh movement, updating focus of the cursor to a respective application window of the plurality of application windows based at least in part on an amount of lateral movement of the seventh movement.

18. The method of claim 15, including while displaying, via the display generation component, the plurality of application windows in the first user interface:
while the current cursor location is at a location corresponding to a first application window of the plurality of application windows, visually emphasizing display of the first application window; and
in response to detecting movement of the input device such that the current cursor location is at a location corresponding to a second application window of the plurality of application windows, visually emphasizing display of the second application window.

19. The method of claim 15, including:
after detecting the change in orientation, in the first direction, of the input device about the axis that is substantially parallel to the physical surface, while the current cursor location is at a location corresponding to a respective application window of the plurality of application windows, detecting a change in orientation, in a second direction different from the first direction, of the input device about the axis that is substantially parallel to the physical surface; and
in response to detecting the change in orientation, in the second direction, of the input device about the axis that is substantially parallel to the physical surface, displaying the respective application window of the plurality of application windows in a foreground of the first user interface.

20. The method of claim 13, including, while displaying a first user interface element in the first user interface and while the current cursor location for the cursor corresponding to the input device is directed to the first user interface element, in response to detecting a change in orientation of the input device about an axis that is substantially perpendicular to the physical surface, performing an operation related to the first user interface element.

21. The method of claim 20, wherein performing the operation related to the first user interface element comprises scrolling through the first user interface element.

22. The method of claim 20, wherein performing the operation related to the first user interface element comprises adjusting a control.

23. The method of claim 20, wherein performing the operation related to the first user interface element comprises adjusting a volume.

24. The method of claim 1, including, while detecting lateral movement of the input device:
detecting a portion of the input device that is facing the display generation component and setting, without additional user input, the detected portion as a front of the input device.

25. The method of claim 1, wherein the input device comprises a symmetrical shape.

26. The method of claim 1, including:
detecting, via the input device, a first portion of a user input for selecting a first object; and
in response to detecting the first portion of the user input for selecting the first object, in accordance with a determination that a second portion of the user input comprises movement of the input device, moving the first object in the first user interface in accordance with the second portion of the user input; and
in response to detecting an end of the user input, displaying the first object at its current location in the first user interface.

27. The method of claim 1, further comprising, in accordance with a determination that the first movement includes a change in orientation of the input device:
in accordance with a determination that that change in orientation of the input device is in a first direction, performing the system operation that is determined based at least in part on an amount of the change in orientation of the first movement; and
in accordance with a determination that that change in orientation of the input device is in a second direction, forgoing performing the system operation.

28. The method of claim 1, further comprising, in accordance with a determination that the first movement includes a change in orientation of the input device:
in accordance with a determination that that change in orientation of the input device is in a clockwise direction, initiating performance of the system operation that is determined based at least in part on an amount of the change in orientation of the first movement; and
in accordance with a determination that that change in orientation of the input device is in a counterclockwise direction, forgoing initiating performance of the system operation.

29. The method of claim 1, further comprising, in accordance with a determination that the first movement includes a change in orientation of the input device:
in accordance with a determination that that change in orientation of the input device is in a first respective direction, performing the system operation that is determined based at least in part on an amount of the change in orientation of the first movement; and
in accordance with a determination that that change in orientation of the input device is in a second respective direction, performing a second system operation, different from the system operation, that is determined based at least in part on an amount of the change in orientation of the first movement.

30. A computer system that is in communication with a display generation component and an input device, comprising:
one or more processors; and
memory storing one or more programs, wherein the one or more programs are configured to be executed by the one or more processors, the one or more programs including instructions for:
while displaying, via the display generation component, a first user interface, while a current cursor location for a cursor corresponding to the input device is at a first location of the first user interface:
in response to detecting first movement of the input device:
in accordance with a determination that the first movement includes lateral movement of the input device relative to a physical surface that the input device is touching, updating display of the cursor as moving based on the lateral movement of the input device on the physical surface; and
in accordance with a determination that the first movement includes a change in orientation of the input device, performing a system operation that is determined based at least in part on an amount of the change in orientation of the first movement.

31. A computer readable storage medium storing one or more programs, the one or more programs comprising instructions that, when executed by a computer system in communication with a display generation component and an input device, cause the computer system to:
while displaying, via the display generation component, a first user interface, while a current cursor location for a cursor corresponding to the input device is at a first location of the first user interface:
in response to detecting first movement of the input device:
in accordance with a determination that the first movement includes lateral movement of the input device relative to a physical surface that the input device is touching, update display of the cursor as moving based on the lateral movement of the input device on the physical surface; and
in accordance with a determination that the first movement includes a change in orientation of the input device, perform a system operation that is determined based at least in part on an amount of the change in orientation of the first movement.
